(19) United States
(12) Patent Application Publication
(10) Pub. No.: US 2019/0306453 A1
(43) Pub. Date: Oct. 3, 2019

(54) INFORMATION RECORDING SYSTEM, INFORMATION RECORDING DEVICE, AND INFORMATION RECORDING METHOD

(71) Applicant: OLYMPUS CORPORATION, Tokyo (JP)

(72) Inventor: Seiji TATSUTA, Tokyo (JP)

(73) Assignee: OLYMPUS CORPORATION, Tokyo (JP)

(21) Appl. No.: 16/445,445

(22) Filed: Jun. 19, 2019

Related U.S. Application Data
(63) Continuation of application No. PCT/JP2017/002749, filed on Jan. 26, 2017.

(51) Int. Cl. H04N 5/77; G11B 27/34; H04N 9/87; G10L 15/26; H04N 9/802; H04N 7/18

(52) U.S. Cl. CPC H04N 5/77; G11B 27/34; H04N 7/18; G10L 15/265; H04N 9/802; H04N 9/87

(57) ABSTRACT

In an information recording system, an object information acquisition unit acquires object information. An image acquisition unit acquires image information indicating a type of situation in which the object information was acquired. A recording unit records the object information, the image information, and time point information on a recording medium such that the object information, the image information, and the time point information are associated with each other. An event detection unit detects an event on the basis of at least one piece of the object information and the image information. A reading unit reads the object information and the image information associated with the time point information corresponding to an event occurrence time point from the recording medium. A display unit displays the object information and the image information such that the object information and the image information are associated with each other.

The present application is a continuation application based on International Patent Application No. PCT/JP2017/002749, filed on Jan. 26, 2017, the content of which is incorporated herein by reference.

### BACKGROUND OF THE INVENTION

### Field of the Invention

The present invention relates to an information recording system, an information recording device, and an information recording method.

### Description of Related Art

The record of a situation at an observation site as well as the record of information obtained by observation is regarded to be important to promote the use of data and prevent fraud. For example, there are examples of a laboratory notebook of a researcher, findings of a doctor, a construction site deployment report, and the like as examples of the record of the situation at the observation site. Also, the declining birthrate and aging population and the shortage of skilled workers have become a problem in every field. For the skill succession and education, the importance of recording of an on-site situation is increasing more and more.

Conventional observation devices record only information of an object obtained by observing the object. At present, a user records a situation of an observation site by writing by hand. On the other hand, because users are working in various environments and situations at a site, there is a case in which it is difficult to record at a site. There are cases in which the users may not use their hands for reasons of safety or hygiene. In these cases, there is a possibility that a user will cause omissions in recording or erroneous recording due to recording an on-site situation on the basis of ambiguous memories after observation.

On the other hand, technology for recording information of an object and other information in association has been disclosed. For example, in the technology disclosed in Japanese Unexamined Patent Application, First Publication No. 2008-199079, the appearance of an object is imaged and a sound uttered by an operator during imaging is acquired. The acquired image of the object and the acquired sound of the operator are recorded in association. In the technology disclosed in Japanese Unexamined Patent Application, First Publication No. 2008-085582, an image and a sound associated therewith are transmitted from a camera to a server. The server converts the received sound into text and generates information to be added to the image on the basis of a conversion result. The server stores the received image in association with the information generated on the basis of the sound.

### SUMMARY OF THE INVENTION

According to a first aspect of the present invention, an information recording system includes an object information acquisition unit, an image acquisition unit, a recording unit, an event detection unit, a reading unit, and a display unit. The object information acquisition unit acquires object information about an object. The image acquisition unit acquires image information indicating a situation in which the object information was acquired by the object information acquisition unit. The recording unit records the object information, the image information, and time point information on a recording medium such that the object information, the image information, and the time point information are associated with each other. The time point information indicates a time point at which the object information was acquired and a time point at which the image information was acquired. The event detection unit detects an event on the basis of at least one piece of the object information and the image information. The event is a state in which the at least one piece of the object information and the image information recorded on the recording medium satisfies a predetermined condition. The reading unit reads the object information and the image information that are associated with the time point information corresponding to an event occurrence time point that is a time point at which the event occurred from the recording medium. The display unit displays the object information and the image information read by the reading unit such that the object information and the image information are associated with each other.

According to a second aspect of the present invention, in the first aspect, the information recording system may further include a situation information acquisition unit configured to acquire situation information that indicates a type of situation in which the object information was acquired and is information other than the image information of the object. The recording unit may record the object information, the image information, the situation information, and the time point information on the recording medium such that the object information, the image information, the situation information, and the time point information are associated with each other. The time point information indicates a time point at which the object information was acquired, a time point at which the image information was acquired, and a time point at which the situation information was acquired. The event detection unit may detect the event on the basis of at least one piece of the object information, the image information, and the situation information recorded on the recording medium. The event is a state in which the at least one piece of the object information, the image information, and the situation information recorded on the recording medium satisfies a predetermined condition.

According to a third aspect of the present invention, in the first aspect, the information recording system may further include a sound acquisition unit configured to acquire sound information based on a sound uttered by an observer who observes the object. The recording unit may record the object information, the image information, the sound information, and the time point information on the recording medium such that the object information, the image information, the sound information, and the time point information are associated with each other. The time point information indicates a time point at which the object information was acquired, a time point at which the image information was acquired, and a time point at which the sound information was acquired. The event detection unit may detect the event on the basis of at least one piece of the object information, the image information, and the sound information recorded on the recording medium. The event is a state in which the at least one piece of the object information, the image information, and the sound information recorded on the recording medium satisfies a predetermined condition.

According to a fourth aspect of the present invention, in the third aspect, the sound information may be a time-series sound signal. The reading unit may read the sound signal from the recording medium and read the object information and the image information that are associated with the time point information corresponding to the event occurrence time point from the recording medium. The display unit may display the sound signal read by the reading unit in a time-series graph such that a change in the sound signal over time is able to be visually recognized. The display unit may display the object information and the image information read by the reading unit such that the object information and the image information are associated with the time-series graph. The display unit may display a position on the time-series graph at a time point corresponding to the event occurrence time point.

According to a fifth aspect of the present invention, in the first aspect, the information recording system may further include a sound acquisition unit and a sound processing unit. The sound acquisition unit acquires sound information based on a sound uttered by an observer who observes the object. The sound processing unit converts the sound information acquired by the sound acquisition unit into text information. The recording unit may record the object information, the image information, the text information, and the time point information on the recording medium such that the object information, the image information, the text information, and the time point information are associated with each other. The time point information indicates a time point at which the object information was acquired, a time point at which the image information was acquired, and a time point at which the sound information that is a source of the text information was acquired. The event detection unit may detect the event on the basis of at least one piece of the object information, the image information, and the text information recorded on the recording medium. The event is a state in which the at least one piece of the object information, the image information, and the text information recorded on the recording medium satisfies a predetermined condition.

According to a sixth aspect of the present invention, in the first aspect, the information recording system may further include a sound acquisition unit and a sound processing unit. The sound acquisition unit acquires sound information based on a sound uttered by an observer who observes the object. The recording unit may record the object information, the image information, the sound information, and the time point information on the recording medium such that the object information, the image information, the sound information, and the time point information are associated with each other. The time point information indicates a time point at which the object information was acquired, a time point at which the image information was acquired, and a time point at which the sound information was acquired. The reading unit may read the sound information from the recording medium. The sound processing unit may convert the sound information read by the reading unit into text information. The recording unit may associate the text information with the object information, the image information, and the time point information recorded on the recording medium and records the text information on the recording medium. The time point information with which the text information is associated indicates a time point at which the sound information that is a source of the text information was acquired. The event detection unit may detect the event on the basis of at least one piece of the object information, the image information, and the text information recorded on the recording medium. The event is a state in which the at least one piece of the object information, the image information, and the text information recorded on the recording medium satisfies a predetermined condition.

According to a seventh aspect of the present invention, in the first aspect, the information recording system may further include an instruction reception unit configured to receive an event selection instruction for selecting any one of events detected by the event detection unit. The reading unit may read the object information and the image information that are associated with the time point information corresponding to the event occurrence time point of the selected event from the recording medium. The selected event is the event corresponding to the event selection instruction received by the instruction reception unit.

According to an eighth aspect of the present invention, in the seventh aspect, the information recording system may further include a sound acquisition unit configured to acquire sound information based on a sound uttered by an observer who observes the object. The sound information is a time-series sound signal. The recording unit may record the object information, the image information, the sound signal, and the time point information on the recording medium such that the object information, the image information, the sound signal, and the time point information are associated with each other. The time point information indicates a time point at which the object information was acquired, a time point at which the image information was acquired, and a time point at which the sound signal was acquired. The reading unit may read the sound signal from the recording medium and read the object information and the image information that are associated with the time point information corresponding to the event occurrence time point of the selected event from the recording medium. The display unit may display the sound signal read by the reading unit in a time-series graph such that a change in the sound signal over time can be visually recognized. The display unit may display the object information and the image information read by the reading unit such that the object information and the image information are associated with the time-series graph. The display unit may display a position on the time-series graph at a time point corresponding to the event occurrence time point of the selected event.

According to a ninth aspect of the present invention, in the eighth aspect, when an event position has been specified in the sound signal displayed by the display unit, the instruction reception unit may receive the event selection instruction. The event position is a position corresponding to the event occurrence time point of the selected event. After the event selection instruction is received by the instruction reception unit, the display unit may display the object information and the image information read by the reading unit such that the object information and the image information are associated with the time-series graph.

According to a tenth aspect of the present invention, in the first aspect, when a state of the object indicated by the object information is a state predefined as an event detection condition, the event detection unit may detect the event.

According to an eleventh aspect of the present invention, in the first aspect, the image acquisition unit may acquire the image information including an image of surroundings of the object. The event detection unit may detect the event when a state of the surroundings of the object indicated by the image information is a state predefined as an event detection condition.

According to a twelfth aspect of the present invention, in the first aspect, the information recording system may further include a sound acquisition unit configured to acquire sound information based on a sound uttered by an observer who observes the object. The sound information is a time-series sound signal. When amplitude or power of the sound signal exceeds a threshold value predefined as an event detection condition, the event detection unit may detect the event.

According to a thirteenth aspect of the present invention, in the first aspect, the information recording system may further include a sound acquisition unit configured to acquire sound information based on a sound uttered by an observer who observes the object. When a sound indicated by the sound information is the same as a sound of a keyword predefined as an event detection condition, the event detection unit may detect the event.

According to a fourteenth aspect of the present invention, in the first aspect, the information recording system may further include a sound acquisition unit and a sound processing unit. The sound acquisition unit acquires sound information based on a sound uttered by an observer who observes the object. The sound processing unit converts the sound information acquired by the sound acquisition unit into text information. When a keyword indicated by the text information is the same as a keyword predetermined as an event detection condition, the event detection unit may detect the event.

According to a fifteenth aspect of the present invention, an information recording device includes an input unit, a recording unit, an event detection unit, and a reading unit. Object information acquired by an object information acquisition unit and image information indicating a situation in which the object information was acquired by the object information acquisition unit are input to the input unit. The object information is information about an object. The recording unit records the object information, the image information, and time point information on a recording medium such that the object information, the image information, and the time point information are associated with each other. The time point information indicates a time point at which the object information was acquired and a time point at which the image information was acquired. The event detection unit detects an event on the basis of at least one piece of the object information and the image information recorded on the recording medium. The event is a state in which the at least one piece of the object information and the image information recorded on the recording medium satisfies a predetermined condition. The reading unit reads the object information and the image information that are associated with the time point information corresponding to an event occurrence time point that is a time point at which the event occurred from the recording medium.

According to a sixteenth aspect of the present invention, an information recording method includes an object information acquisition step, an image acquisition step, a recording step, an event detection step, a reading step, and a display step. In the object information acquisition step, an object information acquisition unit acquires object information about an object. In the image acquisition step, an image acquisition unit acquires image information indicating a situation in which the object information was acquired by the object information acquisition unit. In the recording step, a recording unit records the object information, the image information, and time point information on a recording medium such that the object information, the image information, and the time point information are associated with each other. The time point information indicates a time point at which the object information was acquired and a time point at which the image information was acquired. In the event detection step, an event detection unit detects an event on the basis of at least one piece of the object information and the image information. The event is a state in which the at least one piece of the object information and the image information recorded on the recording medium satisfies a predetermined condition. In the reading step, a reading unit reads the object information and the image information that are associated with the time point information corresponding to an event occurrence time point that is a time point at which the event occurred from the recording medium. In the display step, a display unit displays the object information and the image information read by the reading unit such that the object information and the image information are associated with each other.

### BRIEF DESCRIPTION OF THE DRAWINGS

FIG. 1 is a block diagram showing a configuration of an information recording system according to a first embodiment of the present invention.

FIG. 2 is a flowchart showing a procedure of processing of the information recording system according to the first embodiment of the present invention.

FIG. 3 is a diagram showing a schematic configuration of a microscope system according to the first embodiment of the present invention.

FIG. 4 is a diagram showing a schematic configuration of an endoscope system according to the first embodiment of the present invention.

FIG. 5 is a diagram showing a schematic configuration of an examination system according to the first embodiment of the present invention.

FIG. 6 is a diagram showing a schematic configuration of an inspection system according to the first embodiment of the present invention.

FIG. 7 is a diagram showing a schematic configuration of a work recording system according to the first embodiment of the present invention.

FIG. 8 is a reference diagram showing event detection based on object information in the information recording system according to the first embodiment of the present invention.

FIG. 9 is a reference diagram showing event detection based on object information in the information recording system according to the first embodiment of the present invention.

FIG. 10 is a reference diagram showing event detection based on sound information in the information recording system according to the first embodiment of the present invention.

FIG. 11 is a reference diagram showing event detection based on sound information in the information recording system according to the first embodiment of the present invention.

FIG. 12 is a reference diagram showing a screen of a display unit in the information recording system according to the first embodiment of the present invention.

FIG. 13 is a reference diagram showing a relationship between an event occurrence time point and an event period in the information recording system according to the first embodiment of the present invention.

FIG. 14 is a block diagram showing a configuration of an information recording system according to a first modified example of the first embodiment of the present invention.

FIG. 15 is a reference diagram showing a screen of a display unit in the information recording system according to the first modified example of the first embodiment of the present invention.

FIG. 16 is a block diagram showing a configuration of an information recording system according to a second modified example of the first embodiment of the present invention.

FIG. 17 is a block diagram showing a configuration of an information recording system according to a third modified example of the first embodiment of the present invention.

FIG. 18 is a flowchart showing a procedure of processing of the information recording system according to the third modified example of the first embodiment of the present invention.

FIG. 19 is a reference diagram showing a screen of a display unit in the information recording system according to the third modified example of the first embodiment of the present invention.

FIG. 20 is a block diagram showing a configuration of an information recording system according to a second embodiment of the present invention.

FIG. 21 is a block diagram showing a configuration of the information recording apparatus according to the second embodiment of the present invention.

FIG. 22 is a flowchart showing a procedure of processing of the information recording device according to the second embodiment of the present invention.

### DETAILED DESCRIPTION OF THE INVENTION

Embodiments of the present invention will be described with reference to the drawings.

### First Embodiment

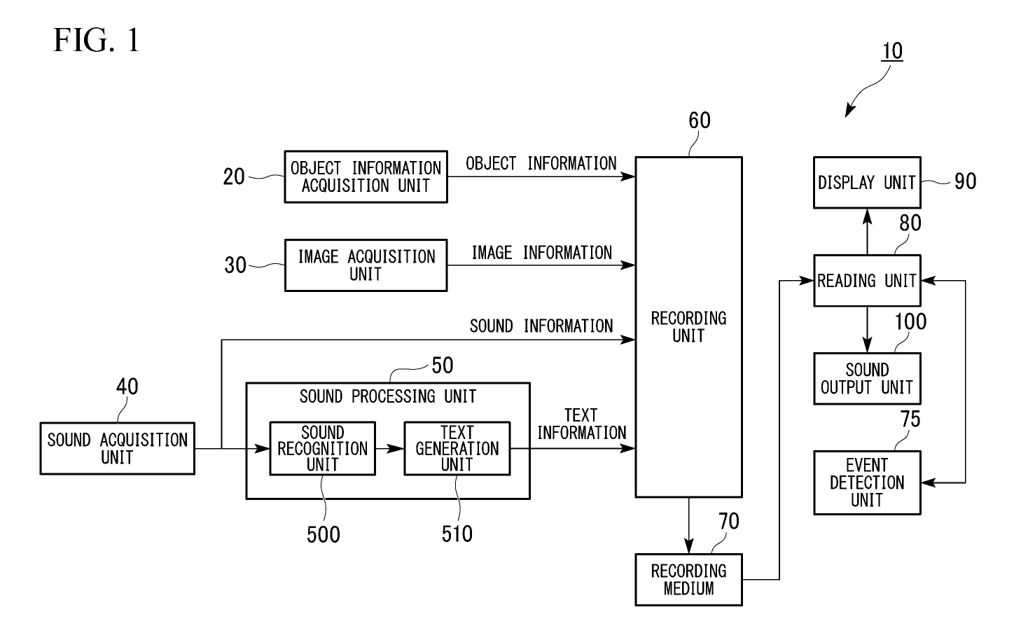

FIG. 1 shows a configuration of an information recording system 10 according to a first embodiment of the present invention. As shown in FIG. 1, the information recording system 10 includes an object information acquisition unit 20, an image acquisition unit 30, a sound acquisition unit 40, a sound processing unit 50, a recording unit 60, a recording medium 70, an event detection unit 75, a reading unit 80, a display unit 90, and a sound output unit 100.

The object information acquisition unit 20 acquires object information about an object. The object is an object to be observed. The observation is an act of figuring out a state of the object. The observation may include acts such as diagnosis, an examination, and an inspection. The object information acquired for observation may not be necessarily visual information of the outside or inside of the object, i.e., image information. For example, the object information acquisition unit 20 is a camera mounted on image devices such as a microscope, an endoscope, a thermal imaging device, an X-ray device, and a computed tomography (CT) device. These image devices acquire image information of the object. These image devices may include a camera that generates image information on the basis of a signal obtained from a sensor. The image information acquired by these image devices may be any one of moving-image information or still-image information. The object information acquisition unit 20 may be a sensor that acquires information such as a temperature, acceleration, pressure, a voltage, and a current of the object. When the object is a living thing, the object information acquisition unit 20 may be a vital sensor that acquires vital information of the object. For example, the vital information is information such as a body temperature, blood pressure, a pulse, an electrocardiogram, or a degree of blood oxygen saturation. The object information acquisition unit 20 may be a microphone that acquires sound information based on a sound uttered by the object. For example, the sound information is information of a hammering test sound, an echo sound, a heart sound, noise, and the like. Additional information such as time point information may be added to the object information acquired by the object information acquisition unit 20. For example, the object information acquisition unit 20 adds time point information indicating a time point at which the object information was acquired to the object information, and outputs the object information to which the time point information is added. When the object information is time-series information, time point information for identifying a plurality of different time points is added to the object information. For example, the time point information associated with the object information includes a time point at which acquisition of the object information was started and a sampling rate.

The image acquisition unit 30 acquires image information indicating a type of situation in which the object information was acquired. The image information acquired by the image acquisition unit 30 indicates a state of at least one of the object and surroundings of the object when the object information is acquired. That is, the image information acquired by the image acquisition unit 30 indicates an observation situation. The image acquisition unit 30 is an image device including a camera. The image acquisition unit 30 acquires the image information in parallel with the acquisition of the object information by the object information acquisition unit 20. The image information acquired by the image acquisition unit 30 may be any one of moving image-information or still-image information. For example, the image acquisition unit 30 acquires the image information including an image of the at least one of the object and the surroundings of the object. For example, the surroundings of the object include a device on which the object information acquisition unit 20 is mounted. In this case, image information including an image of at least one of the object and the device on which the object information acquisition unit 20 is mounted is acquired. The surroundings of the object may also include an observer who observes the object. In this case, image information including an image of at least one of the object and the observer is acquired. The image acquisition unit 30 is disposed such that at least one of the object and the surroundings of the object is included in a photographing range.

When the image information acquired by the image acquisition unit 30 includes an image of the object, the image information includes an image of a part or all of the object. When the image information acquired by the image acquisition unit 30 includes an image of the device on which the object information acquisition unit 20 is mounted, the image information includes an image of a part or all of the device. When the image information acquired by the image acquisition unit 30 includes an image of a user, the image information includes an image of a part or all of the user. When the object information acquisition unit 20 is an image device and the object information is an image of the object, a photographic visual field of the image acquisition unit 30 is wider than that of the object information acquisition unit 20. For example, the object information acquisition unit 20 acquires image information of a part of the object and the image acquisition unit 30 acquires image information of all of the object. The image acquisition unit 30 may be a wearable camera worn by the user, i.e., an observer. For example, the wearable camera is a head mount type camera mounted in the vicinity of the eyes of the observer such that image information corresponding to the viewpoint of the observer can be acquired. Therefore, the image acquisition unit 30 may be disposed at a position of the viewpoint of the observer who observes the object or in the vicinity of the viewpoint. Additional information such as time point information may be added to the image information acquired by the image acquisition unit 30. For example, the image acquisition unit 30 adds the time point information indicating a time point at which the image information was acquired to the image information and outputs the image information to which the time point information is added. When the image information is time-series information, time point information for identifying a plurality of different time points is added to the image information. For example, the time point information associated with the image information includes a time point at which acquisition of the image information was started and a sampling rate.

The sound acquisition unit 40 acquires sound information based on a sound uttered by the observer who observes the object. For example, the sound acquisition unit 40 is a microphone. The sound acquisition unit 40 may be a wearable microphone worn by the observer. The wearable microphone is worn in the vicinity of the observer's mouth. The sound acquisition unit 40 may be a microphone having directivity such that only the sound of the observer is acquired. In this case, the sound acquisition unit 40 may not be installed in the vicinity of the observer's mouth. Thereby, a degree of freedom with respect to the disposition of the sound acquisition unit 40 is obtained. Because noise other than the sound of the observer is eliminated, the efficiency in generation and retrieval of text information is improved. In parallel with the acquisition of the object information by the object information acquisition unit 20, the sound acquisition unit 40 acquires sound information. Additional information such as time point information may be added to the sound information acquired by the sound acquisition unit 40. For example, the sound acquisition unit 40 adds the time point information indicating a time point at which the sound information was acquired to the sound information and outputs the sound information to which the time point information is added. When the sound information is time-series information, the time point information for identifying a plurality of different time points is added to the sound information. For example, the time point information associated with the sound information includes a time point at which acquisition of the sound information was started and a sampling rate.

The sound processing unit 50 converts the sound information acquired by the sound acquisition unit 40 into text information. For example, the sound processing unit 50 includes a sound processing circuit that performs sound processing. The sound processing unit 50 includes a sound recognition unit 500 and a text generation unit 510. The sound recognition unit 500 recognizes a sound of the user, i.e., the observer, on the basis of the sound information acquired by the sound acquisition unit 40. The text generation unit 510 generates text information corresponding to the user's sound by converting the sound recognized by the sound recognition unit 500 into the text information. The text generation unit 510 may divide consecutive sounds into appropriate blocks and generate text information for each block. Additional information such as time point information may be added to the text information generated by the sound processing unit 50. For example, the sound processing unit 50 (the text generation unit 510) adds the time point information indicating a time point at which the text information was generated to the text information and outputs the text information to which the time point information is added. When the text information is time-series information, the time point information corresponding to a plurality of different time points is added to the text information. A time point of the text information corresponds to a start time point of the sound information associated with the text information.

The object information acquired by the object information acquisition unit 20, the image information acquired by the image acquisition unit 30, the sound information acquired by the sound acquisition unit 40, and the text information generated by the sound processing unit 50 are input to the recording unit 60. The recording unit 60 records the object information, the image information, the sound information, the text information, and the time point information on the recording medium 70 such that the object information, the image information, the sound information, the text information, and the time point information are associated with each other. At this time, the recording unit 60 associates the object information, the image information, the sound information, and the text information with each other on the basis of the time point information. For example, the recording unit 60 includes a recording processing circuit that performs an information recording process. At least one piece of the object information, the image information, the sound information, and the text information may be compressed. Therefore, the recording unit 60 may include a compression processing circuit for compressing information. The recording unit 60 may include a buffer for the recording process and the compression process. The time point information indicates time points at which the object information, the image information, and the sound information were acquired. The time point information associated with the text information indicates a time point at which the sound information that is a source of the text information was acquired. For example, the time point information is added to the object information, the image information, the sound information, and the text information. The object information, the image information, the sound information, and the text information are associated with each other via the time point information.

The object information, the image information, the sound information, and the text information are associated with each other as information about a common object. The object information, the image information, the sound information, and the text information may be associated with each other as information about a plurality of objects related to each other. For example, each piece of the object information, the image information, the sound information, and the text information includes one file and the recording unit 60 records each file on the recording medium 70. In this case, information for associating files of the object information, the image information, the sound information, and the text information is recorded on the recording medium 70.

The recording medium 70 is a nonvolatile storage device. For example, the recording medium 70 is at least one of an erasable programmable read only memory (EPROM), an electrically erasable programmable read-only memory (EEPROM), a flash memory, and a hard disk drive. The recording medium 70 may not be disposed at an observation site. For example, the information recording system 10 may have a network interface and the information recording system 10 may be connected to the recording medium 70 via a network such as the Internet or a local area network (LAN). The information recording system 10 may have a wireless communication interface and the information recording system 10 may be connected to the recording medium 70 through wireless communication according to a standard such as Wi-Fi (registered trademark) or Bluetooth (registered trademark). Therefore, the information recording system 10 may not directly include the recording medium 70.

The event detection unit 75 detects an event on the basis of at least one piece of the object information, the image information, the sound information, and the text information recorded on the recording medium 70. The event is a state in which the at least one piece of the object information, the image information, the sound information, and the text information recorded on the recording medium 70 satisfies a predetermined condition. For example, the event detection unit 75 includes an information processing circuit that performs information processing. When the event detection unit 75 processes the image information, the event detection unit 75 includes an image processing circuit. When the event detection unit 75 processes the sound information, the event detection unit 75 includes a sound processing circuit. For example, the at least one piece of the object information, the image information, the sound information, and the text information recorded on the recording medium 70 is read by the reading unit 80. The event detection unit 75 detects an event on the basis of the information read by the reading unit 80. Also, the time point information recorded on the recording medium 70 is read by the reading unit 80. The event detection unit 75 recognizes the event occurrence time point which is a time point at which the event occurred on the basis of a relationship between the time point information read by the reading unit 80 and information in which the event occurred. The recording unit 60 may record the event occurrence time point recognized by the event detection unit 75 on the recording medium 70.

The reading unit 80 reads the object information, the image information, the sound information, and the text information from the recording medium 70. Thereby, the reading unit 80 reproduces the object information, the image information, the sound information, and the text information recorded on the recording medium 70. For example, the reading unit 80 includes a reading processing circuit that performs an information reading process. At least one piece of the object information, the image information, the sound information, and the text information recorded on the recording medium 70 may be compressed. Therefore, the reading unit 80 may include a decompression processing circuit for decompressing the compressed information. The reading unit 80 may include a buffer for a reading process and a decompression process. The reading unit 80 reads the object information, the image information, the sound information, and the text information associated with the time point information corresponding to the event occurrence time point which is the time point at which the event occurred from the recording medium 70. For example, the reading unit 80 reads the object information, the image information, the sound information, and the text information associated with the same time point information corresponding to the event occurrence time point. When pieces of time point information associated with the information are not synchronized with each other, the reading unit 80 may read the information in consideration of a difference in the time point information with respect to a reference time point.

The display unit 90 displays the object information, the image information, the sound information, and the text information read by the reading unit 80 such that the object information, the image information, the sound information, and the text information are associated with each other. The display unit 90 is a display device such as a liquid crystal display. For example, the display unit 90 is a monitor of a personal computer (PC). The display unit 90 may be a wearable display such as smart glasses worn by the user. The display unit 90 may be a display unit of a device on which the object information acquisition unit 20 is mounted. The display unit 90 may be a large-size monitor for sharing information. The display unit 90 may be a touch panel display. For example, the display unit 90 simultaneously displays the object information, the image information, the sound information, and the text information. At this time, the display unit 90 displays the object information, the image information, the sound information, and the text information in a state in which these pieces of information are arranged. Information selected from the object information, the image information, and the text information corresponding to the same event may be displayed on the display unit 90 and the user may be able to switch the information that is displayed on the display unit 90. For example, the object information acquired by the sensor or the vital sensor includes a time-series sensor signal. For example, the display unit 90 displays a waveform of a sensor signal as a graph. For example the sound information includes a time-series sound signal. For example, the display unit 90 displays a change in amplitude or power of the sound signal over time as a graph.

The sound output unit 100 outputs a sound based on the sound information read by the reading unit 80. For example, the sound output unit 100 is a speaker.

When the object information acquired by the object information acquisition unit 20 is image information, the object information may be output to the display unit 90. The display unit 90 may display the object information in parallel with the acquisition of the object information by the object information acquisition unit 20. The image information acquired by the image acquisition unit 30 may be output to the display unit 90. The display unit 90 may display the image information acquired by the image acquisition unit 30 in parallel with the acquisition of the object information by the object information acquisition unit 20. Thereby, the user can figure out a state of the object and an observation situation in real time.

The sound processing unit 50, the recording unit 60, the event detection unit 75, and the reading unit 80 may include one or more processors. For example, the processor is at least one of a central processing unit (CPU), a digital signal processor (DSP), and a graphics processing unit (GPU). The sound processing unit 50, the recording unit 60, the event detection unit 75, and the reading unit 80 may include an application specific integrated circuit (ASIC) or a field-programmable gate array (FPGA).

In the information recording system 10, the sound acquisition and recording are optional. Therefore, the information recording system 10 may not include the sound acquisition unit 40, the sound processing unit 50, and the sound output unit 100. In this case, the recording unit 60 records the object information, the image information, and the time point information on the recording medium 70 such that the object information, the image information, and the time point information are associated with each other. The time point information indicates time points at which the object information and the image information were acquired. The event detection unit 75 detects an event on the basis of at least one piece of the object information and the image information recorded on the recording medium 70. The event is a state in which the at least one piece of the object information and the image information recorded on the recording medium 70 satisfies a predetermined condition. The reading unit 80 reads the object information and the image information associated with the time point information corresponding to the event occurrence time point from the recording medium 70. The display unit 90 displays the object information and the image information read by the reading unit 80 such that the object information and the image information are associated with each other.

The information recording system 10 may not include the sound processing unit 50. In this case, the recording unit 60 records the object information, the image information, the sound information, and the time point information on the recording medium 70 such that the object information, the image information, the sound information, and the time point information are associated with each other. The time point information indicates time points at which the object information, the image information, and the sound information were acquired. The event detection unit 75 detects an event on the basis of at least one piece of the object information, the image information, and the sound information recorded on the recording medium 70. The event is a state in which the at least one piece of the object information, the image information, and the sound information recorded on the recording medium 70 satisfies a predetermined condition. The reading unit 80 reads the object information, the image information, and the sound information associated with the time point information corresponding to the event occurrence time point from the recording medium 70. The display unit 90 displays the object information, the image information, and the sound information read by the reading unit 80 such that the object information, the image information, and the sound information are associated with each other. The sound output unit 100 outputs a sound based on the sound information read by the reading unit 80. Although the sound information is used for detecting the event, the sound information may not be displayed and the sound may not be output by the sound output unit 100.

The information recording system 10 may not include the sound output unit 100 and the recording unit 60 may not record the sound information. In this case, the recording unit 60 records the object information, the image information, the text information, and the time point information on the recording medium 70 such that the object information, the image information, the text information, and the time point information are associated with each other. The time point information indicates time points at which the object information and the image information were acquired and also indicates a time point at which the sound information that is a source of the text information was acquired. The event detection unit 75 detects an event on the basis of at least one of the object information, the image information, and the text information recorded on the recording medium 70. The event is a state in which the at least one of the object information, the image information, and the text information recorded on the recording medium 70 satisfies a predetermined condition. The reading unit 80 reads the object information, the image information, and the text information associated with the time point information corresponding to the event occurrence time point from the recording medium 70. The display unit 90 displays the object information, the image information, and the text information read by the reading unit 80 such that the object information, the image information, and the text information are associated with each other. Although the text information is used for detecting the event, no text information may be displayed.

The information recording system 10 may include an operation unit that receives an operation by the user. For example, the operation unit is configured to include at least one of a button, a switch, a key, a mouse, a joystick, a touch pad, a track ball, and a touch panel.

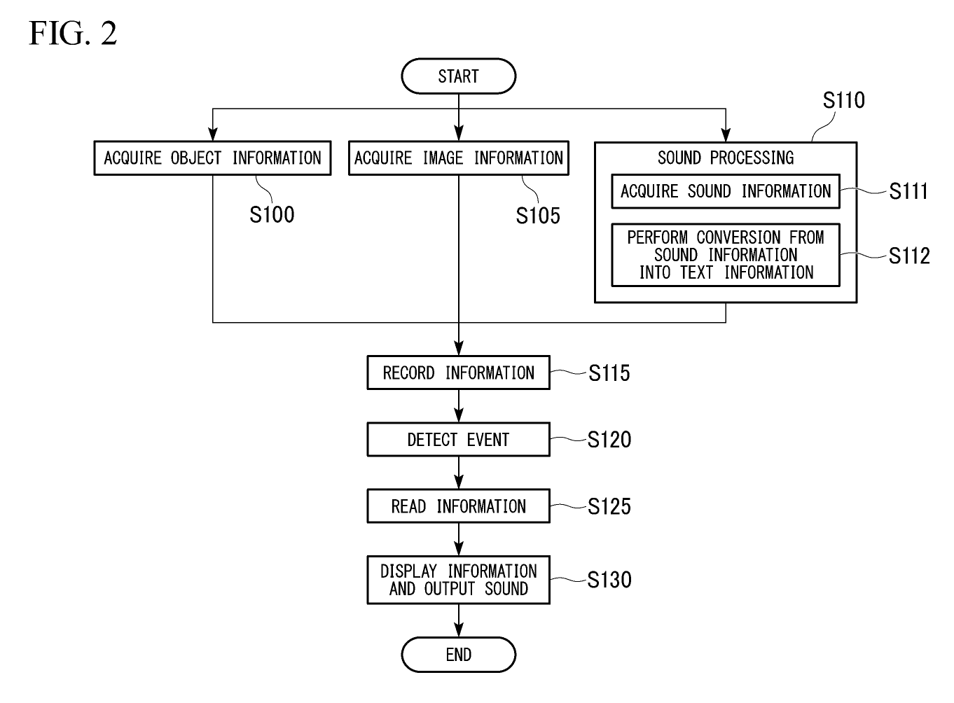

FIG. 2 shows a procedure of processing of the information recording system 10. The procedure of processing of the information recording system 10 will be described with reference to FIG. 2.

The object information acquisition unit 20 acquires object information about an object (step S100 (an object information acquisition step)). The object information acquired in step S100 is stored in the buffer within the recording unit 60. In parallel with the acquisition of the object information by the object information acquisition unit 20, the image acquisition unit 30 acquires image information indicating a type of situation in which the object information was acquired (step S105 (an image acquisition step)). The image information acquired in step S105 is stored in the buffer within the recording unit 60. In parallel with the acquisition of the object information by the object information acquisition unit 20, the processing in step S110 is performed. Step S110 includes step S111 (a sound acquisition step) and step S112 (a sound processing step). In step S111, the sound acquisition unit 40 acquires sound information based on a sound uttered by the observer who observes the object. In step S112, the sound processing unit 50 converts the sound information acquired by the sound acquisition unit 40 into text information. In step S110, the processing in step S111 and step S112 is iterated. The sound information acquired in step S111 and the text information generated in step S112 are stored in the buffer within the recording unit 60. Also, the time point information corresponding to a time point at which the information was generated is stored in the buffer within the recording unit 60.

Processing start timings of step S100, step S105, and step S110 may not be the same. Processing end timings of step S100, step S105, and step S110 may not be the same. At least some of periods during which the processing in step S100, step S105, and step S110 is performed overlap each other.

After the acquisition of the object information, the image information, and the sound information is completed, the recording unit 60 records the object information, the image information, the sound information, the text information, and the time point information stored in the buffer within the recording unit 60 on the recording medium 70 such that the object information, the image information, the sound information, the text information, and the time point information are associated with each other (step S115 (a recording step)).

After step S115, the event detection unit 75 detects the event on the basis of at least one piece of the object information, the image information, the sound information, and the text information recorded on the recording medium 70 (step S120 (an event detection step)).

After step S120, the reading unit 80 reads the object information, the image information, the sound information, and the text information associated with the time point information corresponding to the event occurrence time point that is a time point at which an event occurred from the recording medium 70 (step S125 (a reading step)). The user may be able to specify a timing at which the information is read.

After step S125, the display unit 90 displays the object information, the image information, the sound information, and the text information read by the reading unit 80 such that the object information, the image information, the sound information, and the text information are associated with each other. Also, the sound output unit 100 outputs a sound based on the sound information read by the reading unit 80 (step S130 (a display step and a sound output step)).

When the information recording system 10 does not include the sound acquisition unit 40, the sound processing unit 50, and the sound output unit 100, the processing in step S110 is not performed. Also, in step S115, the recording unit 60 records the object information, the image information, and the time point information on the recording medium 70 such that the object information, the image information, and the time point information are associated with each other. In step S120, the event detection unit 75 detects the event on the basis of at least one piece of the object information and the image information recorded on the recording medium 70. In step S125, the reading unit 80 reads the object information and the image information associated with the time point information corresponding to the event occurrence time point from the recording medium 70. In step S130, the display unit 90 displays the object information and the image information read by the reading unit 80 in step S125 such that the object information and the image information are associated with each other.

When the information recording system 10 does not include the sound processing unit 50, the processing in step S112 is not performed. Also, in step S115, the recording unit 60 records the object information, the image information, the sound information, and the time point information on the recording medium 70 such that the object information, the image information, the sound information, and the time point information are associated with each other. In step S120, the event detection unit 75 detects the event on the basis of at least one piece of the object information, the image information, and the sound information recorded on the recording medium 70. In step S125, the reading unit 80 reads the object information, the image information, and the sound information associated with the time point information corresponding to the event occurrence time point from the recording medium 70. In step S130, the display unit 90 displays the object information, the image information, and the sound information read by the reading unit 80 in step S125 such that the object information, the image information, and the sound information are associated with each other. No sound information may be displayed. Also, in step S130, the sound output unit 100 outputs a sound based on the sound information read by the reading unit 80 in step S125. No sound may be output.

When the information recording system 10 does not include the sound output unit 100 and the recording unit 60 does not record the sound information, the recording unit 60 records the object information, the image information, the text information, and the time point information on the recording medium 70 such that the object information, the image information, the text information, and the time point information are associated with each other in step S115. In step S120, the event detection unit 75 detects the event on the basis of at least one piece of the object information, the image information, and the text information recorded on the recording medium 70. In step S125, the reading unit 80 reads the object information, the image information, and the text information associated with the time point information corresponding to the event occurrence time point from the recording medium 70. In step S130, the display unit 90 displays the object information, the image information, and the text information read by the reading unit 80 in step S120 such that the object information, the image information, and the text information are associated with each other. No text information may be displayed.

As described above, the object information is acquired by the object information acquisition unit 20 and the image acquisition unit 30 acquires the image information indicating a type of situation in which the object information was acquired. The acquired object information and image information are recorded on the recording medium 70 by the recording unit 60. Thereby, the information recording system 10 can record visual information indicating a type of situation in which the object information was acquired.

In the above-described method, a burden on the user for recording the information indicating a type of situation in which the object information was acquired is small. Even when the user cannot use his/her hand, necessary information can be recorded and omissions in recording or erroneous recording are reduced. Therefore, the information recording system 10 can accurately and efficiently leave a record showing the type of situation in which the object information was acquired.

In the above-described method, the user's comments when the object information was acquired are recorded as a sound and text corresponding to the sound is recorded in association with the object information and the image information. A “tag” based on the text is attached to the object information, the image information, and the sound information and therefore browsability and searchability of the information are improved. Also, the user can easily understand a situation when the information was acquired.

In the above-described method, an event is detected on the basis of at least one piece of the object information and the image information recorded on the recording medium 70 and the object information and the image information corresponding to the event occurrence time point are displayed such that the object information and the image information are associated with each other. Thereby, the information recording system 10 can support efficient information viewing by the user.

According to the above-described method, the information recording system 10 can extract a useful scene to which the user pays attention and a list of information about the scene from a plurality of pieces of and a large amount of information recorded at the observation site. Therefore, the user can efficiently view information about an event occurring at a timing when the user pays attention.

A specific example of the information recording system 10 will be described below.

### Observation with Microscope

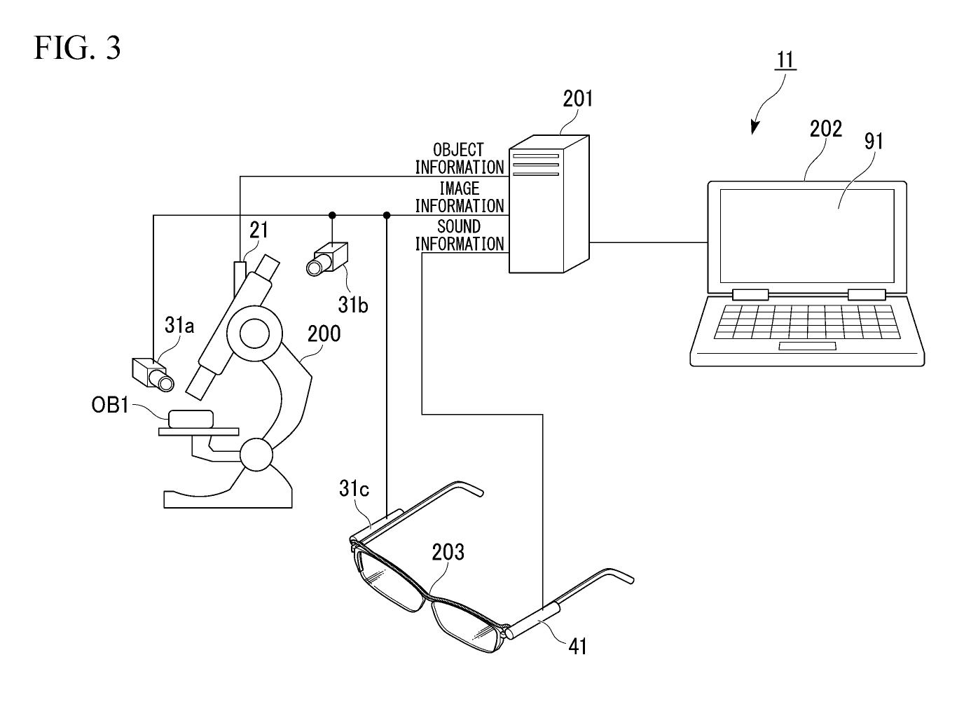

FIG. 3 shows a schematic configuration of a microscope system 11 which is an example of the information recording system 10. As shown in FIG. 3, the microscope system 11 includes a microscope 200, a camera 31a, a camera 31b, a camera 31c, a microphone 41, a server 201, and a PC 202.

The microscope 200 is a device for enlarging and observing an object OB1. The camera 21 connected to the microscope 200 constitutes the object information acquisition unit 20. The camera 21 acquires image information of the object OB1 enlarged by the microscope 200 as object information. For example, the camera 21 acquires moving-image information.

The camera 31a, the camera 31b, and the camera 31c constitute the image acquisition unit 30. A photographic visual field of each of the camera 31a, the camera 31b, and the camera 31c is wider than that of the camera connected to the microscope 200. For example, the camera 31a, the camera 31b, and the camera 31c acquire moving-image information.

The camera 31a is disposed in the vicinity of a tip of an objective lens of the microscope 200. The camera 31a acquires image information including an image of the object OB1 and the tip of the objective lens of the microscope 200 by photographing the vicinity of the tip of the objective lens of the microscope 200. Thereby, a positional relationship between the object OB1 and the tip of the objective lens of the microscope 200 is recorded as image information. The user who is the observer does not need to approach the object OB1 and the tip of the objective lens of the microscope 200 to check states thereof. By viewing the image information acquired by the camera 31a, the user can easily figure out a situation such as which part of the object OB1 is being observed or how close the objective lens tip of the microscope 200 is to the object OB1.

The camera 31b is disposed in an indoor space where observation is performed. The camera 31b acquires image information including an image of all of the object OB1 and the microscope 200 by photographing all of the object OB1 and the microscope 200. Thereby, all situations of an observation site are recorded as the image information. By viewing the image information acquired by the camera 31b, the user can easily figure out a situation such as an event occurring in a portion different from a portion to which the user is paying attention. When the object OB1 is a living thing, the state of the object OB1 is likely to affect the object information obtained by observation. For example, even when it is difficult to determine a state related to death and life of the object OB1 from the object information, the user can easily figure out the state of the object OB1 by viewing the image information acquired by the camera 31b. The camera 31b may acquire image information including an image of the user.

The camera 31c is configured as a wearable camera. The camera 31c is configured as the wearable camera by being attached to an accessory 203 capable of being attached to the user's head. When the user wears the accessory 203, the camera 31c is disposed at a position near a viewpoint of the user. The camera 31c acquires image information including an image of the object OB1 and the microscope 200 by photographing the object OB1 and the microscope 200. Alternatively, the camera 31c acquires image information including an image of the microscope 200 without including an image of the object OB1 by photographing the microscope 200. Thereby, an observation situation corresponding to a part to which the user is paying attention in observation is recorded as the image information. Thereby, the microscope system 11 can record observation states such as a situation before the object OB1 is set up on a microscope stage, a procedure of adjusting the microscope 200, and an adjustment state of the microscope 200. The user, other people, and the like can easily figure out a situation during the observation in real time or after the end of observation by viewing the recorded observation states.

The microphone 41 constitutes the sound acquisition unit 40. The microphone 41 is configured as a wearable microphone by being attached to the accessory 203.

The server 201 includes the sound processing unit 50, the recording unit 60, a recording medium 70, the event detection unit 75, and the reading unit 80. The object information acquired by the camera 21, the image information acquired by the camera 31a, the camera 31b and the camera 31c, and the sound information acquired by the microphone 41 are input to the server 201.

The PC 202 is connected to the server 201. The screen 91 of the PC 202 constitutes the display unit 90. The smart glasses may constitute the display unit 90. In parallel with the acquisition of the object information, the smart glasses may display the image information that is the object information and the image information acquired by each of the camera 31a, the camera 31b, and the camera 31c. By wearing the smart glasses, the user can figure out the state of the object OB1 and the observation situation in real time.

The information recording system 10 may be applied to a microscope system using a multiphoton excitation fluorescence microscope. The multiphoton excitation fluorescence microscope is used within a dark room. A camera connected to the multiphoton excitation fluorescence microscope constitutes the object information acquisition unit 20. For example, as infrared cameras, the camera 31a, the camera 31b, and the camera 31c constitute the image acquisition unit 30. The infrared camera acquires image information including an image of all of the object and the multiphoton excitation fluorescence microscope by photographing all of the object and the multiphoton excitation fluorescence microscope. For example, the user who is an observer wears a wearable microphone constituting the sound acquisition unit 40. A device such as a PC includes the sound processing unit 50, the recording unit 60, the recording medium 70, the event detection unit 75, and the reading unit 80. The object information acquired by the camera connected to the multiphoton excitation fluorescence microscope, the image information acquired by the infrared camera, and the sound information acquired by the wearable microphone are input to the device. The screen of the device constitutes the display unit 90.

In a dark environment, it is difficult for the user to figure out the state of the microscope and the situation of the experiment and write the state and the situation that have been figured out on paper with the user's hand. In a system to which the information recording system 10 is applied, the user does not need to stop the experiment and turn on a light in order to know the state of the microscope and the situation of the experiment. Also, the user does not need to temporarily stop the microscope and look into the dark room. Also, the user does not need to manually write the state of the microscope and the situation of the experiment on paper with his/her hand.

### Inspection with Endoscope

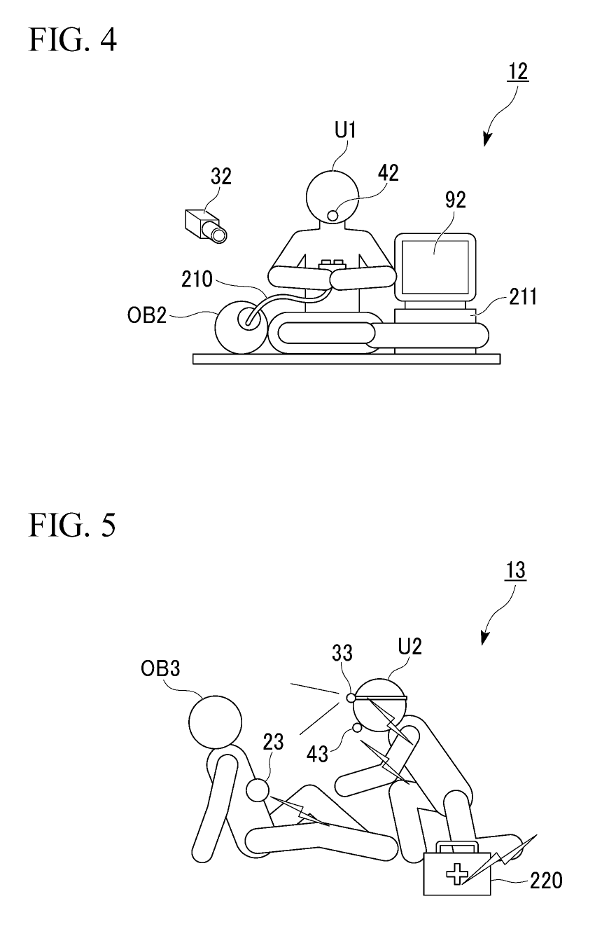

FIG. 4 shows a schematic configuration of the endoscope system 12 which is an example of the information recording system 10. As shown in FIG. 4, the endoscope system 12 includes an endoscope 210, a camera 32, a microphone 42, and a PC 211.

The endoscope 210 is inserted into an object OB2. The object OB2 is a person who is undergoing an endoscopic inspection, i.e., a patient. The endoscope 210 is a device for observing the inside of the object OB2. A camera disposed on a tip of the endoscope 210 constitutes the object information acquisition unit 20. This camera acquires image information of the inside of the body of the object OB2 as object information. For example, this camera acquires moving-image information and still-image information.

The camera 32 constitutes the image acquisition unit 30. The camera 32 is disposed within an indoor space where an inspection is performed. For example, the camera 32 acquires moving-image information including an image of the object OB2 and the endoscope 210 as image information by photographing the object OB2 and the endoscope 210. Thereby, a situation of the inspection is recorded as image information. The camera 32 may acquire the image information including an image of a user U1. For example, the user U1 is a doctor. Thereby, the endoscope system 12 can record inspection states such as a procedure and method of inserting the endoscope 210, the motion of the object OB2, the motion of the user U1, and the like. The user U1, another doctor, an assistant, and the like can easily figure out a situation during the inspection in real time or after the end of the inspection by viewing the recorded inspection states.

The microphone 42 constitutes the sound acquisition unit 40. The microphone 42 is attached to the user U1 as a wearable microphone. The user U1 utters comments simultaneously with the inspection with the endoscope 210. The comments uttered by the user U1 are recorded in association with the object information and the image information. Thus, the user U1 can efficiently create an accurate inspection record to be used for the purpose of creating findings, materials for conference presentation, educational content for less experienced doctors, and the like.

The PC 211 includes the sound processing unit 50, the recording unit 60, the recording medium 70, the event detection unit 75, and the reading unit 80. The object information acquired by the camera disposed at the tip of the endoscope 210, the image information acquired by the camera 32, and the sound information acquired by the microphone 42 are input to the PC 211. A screen 92 of the PC 211 constitutes the display unit 90.

### Examination at Emergency Site

FIG. 5 shows a schematic configuration of an examination system 13 which is an example of the information recording system 10. As shown in FIG. 5, the examination system 13 includes a vital sensor 23, a camera 33, a microphone 43, and a device 220.

The vital sensor 23 is attached to an object OB3. The object OB3 is a person to be examined, i.e., a patient. The vital sensor 23 constitutes the object information acquisition unit 20. The vital sensor 23 acquires biological information such as a body temperature, blood pressure, and a pulse of the object OB3 as object information.

The camera 33 constitutes the image acquisition unit 30. As a wearable camera, the camera 33 is attached to a user U2. For example, the camera 33 acquires moving-image information. The camera 33 acquires image information including an image of on-site situations of the object OB3, the hands of the user U2, and the like by photographing the on-site situations of the object OB3, the hands of the user U2, and the like. Thereby, a site, a condition of a patient, an examination situation, and the like are recorded as the image information. For example, the user U2 is a doctor or an emergency crew member. Thereby, the examination system 13 can record situations such as an examination procedure, details of a treatment on the object OB3, and a state of the object OB3. The user U2 and other doctors can easily figure out the site, the condition of the patient, the examination situation and the like in real time or after the end of the examination by viewing the recorded situations.

The microphone 43 constitutes the sound acquisition unit 40. As a wearable microphone, the microphone 43 is attached to the user U2. The user U2 utters comments simultaneously with the acquisition of the object information by the vital sensor 23. The comments uttered by the user U2 are recorded in association with the object information and the image information. Thus, the user U2 can efficiently and accurately deliver findings on the site with respect to the object OB3 to people such as other doctors.

The device 220 includes the sound processing unit 50, the recording unit 60, the recording medium 70, the event detection unit 75, and the reading unit 80. The object information acquired by the vital sensor 23, the image information acquired by the camera 33, and the sound information acquired by the microphone 43 are input to the device 220. The information is wirelessly transmitted to the device 220. The device 220 wirelessly receives the information. The screen of the device 220 constitutes the display unit 90. The device 220 may wirelessly transmit the input information to the server. For example, the server includes the sound processing unit 50, the recording unit 60, the recording medium 70, the event detection unit 75, and the reading unit 80. A doctor in a hospital can easily figure out the state of the patient by viewing the information received by the server.

### Non-Destructive Inspection

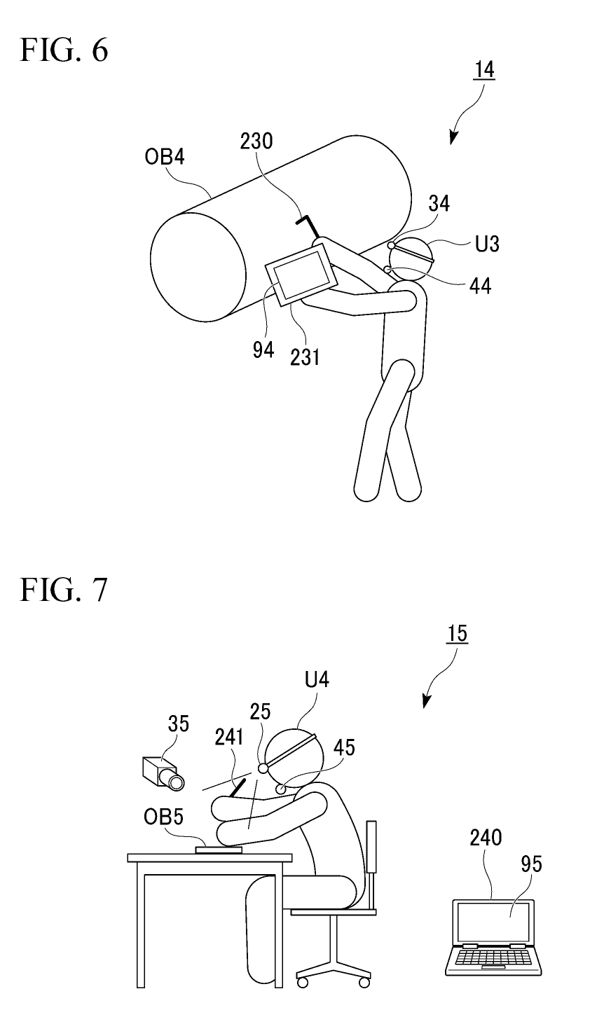

FIG. 6 shows a schematic configuration of an inspection system 14 which is an example of the information recording system 10. As shown in FIG. 6, the inspection system 14 includes a probe 230, a camera 34, a microphone 44, and a device 231.

The probe 230 constitutes the object information acquisition unit 20. The probe 230 acquires a signal such as an electric current corresponding to a defect on a surface of an object OB4 as object information. The object OB4 is an industrial product to be inspected. For example, the object OB4 is a plant pipe or an aircraft fuselage.

The camera 34 constitutes the image acquisition unit 30. As a wearable camera, the camera 34 is attached to a user U3. For example, the camera 34 acquires moving-image information. The camera 34 acquires image information including an image of the object OB4 and the probe 230 by photographing the object OB4 and the probe 230. Thereby, the situation of the non-destructive inspection is recorded as the image information. For example, the user U3 is an inspector. Thereby, the inspection system 14 can record inspection situations such as an inspection position and an inspection procedure in the object OB4. The user U3, other technicians, and the like can easily figure out a situation during the inspection in real time or after the end of the inspection by viewing the recorded inspection situations.

The microphone 44 constitutes the sound acquisition unit 40. As a wearable microphone, the microphone 44 is attached to the user U3. The user U3 utters comments simultaneously with the acquisition of the object information by the probe 230. The comments uttered by the user U3 are recorded in association with the object information and the image information. Thus, the user U3 can accurately and efficiently create a work report concerning the inspection of the object OB4.

The device 231 includes the sound processing unit 50, the recording unit 60, the recording medium 70, the event detection unit 75, and the reading unit 80. The object information acquired by the probe 230, the image information acquired by the camera 34, and the sound information acquired by the microphone 44 are input to the device 231. A screen 94 of the device 231 constitutes the display unit 90. The device 231 may wirelessly transmit the information to the server. For example, the server includes the sound processing unit 50, the recording unit 60, the recording medium 70, the event detection unit 75, and the reading unit 80. A technician who is away from the site can easily figure out the state of the inspection by viewing the information received by the server. Also, the user U3 can receive an instruction from the technician at a remote place by receiving information transmitted from the technician through the device 231 or another reception device.

The information recording system 10 may be applied to an inspection system using an industrial endoscope. Industrial endoscopes acquire image information of objects such as scratches and corrosion inside objects such as boilers, turbines, engines, and chemical plants. The scope constitutes the object information acquisition unit 20. For example, a user who is an inspector wears the wearable camera constituting the image acquisition unit 30 and the wearable microphone constituting the sound acquisition unit 40. A main body of the endoscope has the sound processing unit 50, the recording unit 60, the recording medium 70, the event detection unit 75, and the reading unit 80. Object information acquired by the scope, image information acquired by the wearable camera, and sound information acquired by the wearable microphone are input to the main body. A screen of the main body constitutes the display unit 90.

### Work Recording System

FIG. 7 shows a schematic configuration of a work recording system 15 which is an example of the information recording system 10. As shown in FIG. 7, the work recording system 15 has a camera 25, a camera 35, a microphone 45, and a PC 240.

The camera 25 constitutes the object information acquisition unit 20. As a wearable camera, the camera 25 is attached to a user U4. The camera 25 acquires image information of an object OB5 as object information. For example, the camera 25 acquires moving-image information. For example, the user U4 is an operator. For example, the object OB5 is a circuit board.

The camera 35 constitutes the image acquisition unit 30. The camera 35 is disposed in an indoor space where work such as repair or assembly of the object OB5 is performed. A visual field of the camera 35 is wider than a visual field of the camera 25. For example, the camera 35 acquires moving-image information. The camera 35 acquires image information including an image of the object OB5 and a tool 241 by photographing the object OB5 and the tool 241 used by the user U4. Thereby, the situation of the work is recorded as the image information. Thereby, the work recording system 15 can record situations such as a work position and a work procedure in the object OBS. The user U4, other technicians, and the like can easily figure out the situation during work in real time or after the end of the work by viewing the recorded situations.

The microphone 45 constitutes the sound acquisition unit 40. As a wearable microphone, the microphone 45 is attached to the user U4. The user U4 utters comments simultaneously with the acquisition of the object information by the camera 25. The comments uttered by the user U4 are recorded in association with the object information and the image information. Thus, the user U4 can efficiently create an accurate work record to be used for the purpose of creating a work report related to work with respect to the object OB5 and educational content for less experienced workers. Also, the user U4 can easily trace work on the basis of a work history when a problem or the like occurs by storing the work record as the work history with respect to the object.

The PC 240 includes the sound processing unit 50, the recording unit 60, the recording medium 70, the event detection unit 75, and the reading unit 80. The object information acquired by the camera 25, the image information acquired by the camera 35, and the sound information acquired by the microphone 45 are input to the PC 240 in a wireless manner or a wired manner (not shown). A screen 95 of the PC 240 constitutes the display unit 90.

A specific example of event detection by the event detection unit 75 will be described below.

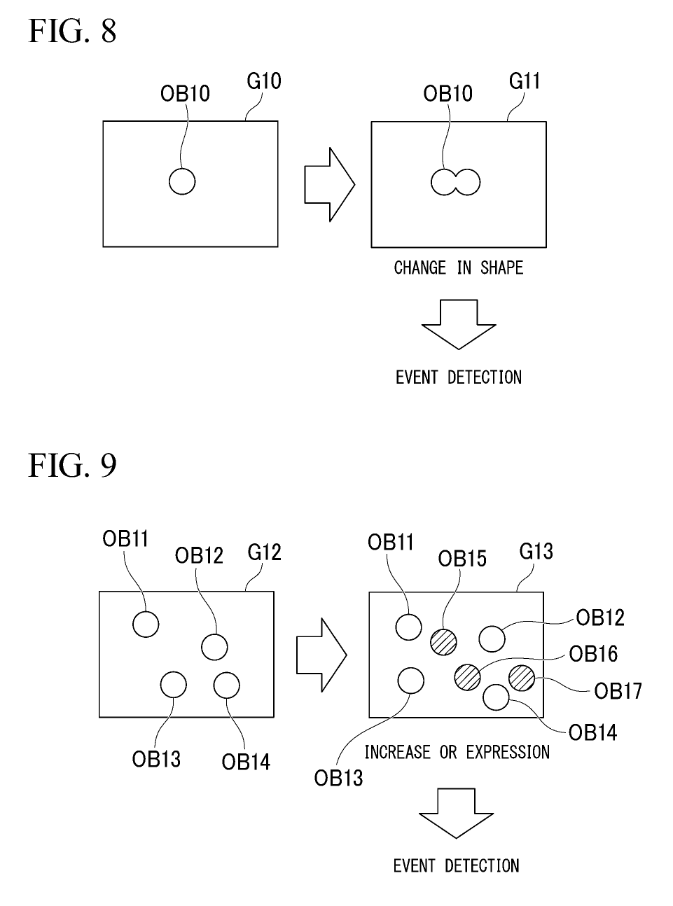

FIGS. 8 and 9 show examples of event detection based on the object information. In FIGS. 8 and 9, the object information is image information (a microscope image) of the object acquired by the camera connected to the microscope.

As shown in FIG. 8, an object OB10 is included in an image G10. An image G11 is captured at a time point later than that when the image G10 was captured. The object OB10 is included in the image G11. The shape of the object OB10 is different between the image G10 and the image G11. That is, the shape of the object OB10 varies with time. When the shape of the object OB10 has changed, the event detection unit 75 detects an event. For example, the event detection unit 75 determines whether or not an event in which the shape of the object OB10 changes has occurred by comparing image information of a plurality of frames acquired at different time points.

As shown in FIG. 9, an object OB11, an object OB12, an object OB13, and an object OB14 are included in an image G12. An image G13 is captured at a time point later than a time point when the image G12 was captured. In addition to the objects OB11 to OB14, an object OB15, an object OB16, and an object OB17 are included in the image G13. The objects OB15 to OB17 are added between the image G12 and the image G13. That is, the number of objects varies with time. When the number of objects has changed, the event detection unit 75 detects an event. For example, the event detection unit 75 determines whether or not an event in which the number of objects changes has occurred by comparing image information of a plurality of frames acquired at different time points.

When a state of the object indicated by the object information is a state predefined as an event detection condition, the event detection unit 75 detects the event. For example, the event detection condition is recorded on the recording medium 70 in advance. The reading unit 80 reads the event detection condition from the recording medium 70. The event detection unit 75 detects an event on the basis of the event detection condition read by the reading unit 80. Thereby, the event detection unit 75 can detect a phenomenon that the object is in a predetermined state as the event.

The image acquisition unit 30 acquires image information including an image of at least one of the object and surroundings of the object. When at least one state of the object and the surroundings of the object indicated by the image information is a state predefined as the event detection condition, the event detection unit 75 detects the event. For example, when a feature of the image information is the same as a feature predefined as the event detection condition, the event detection unit 75 detects the event. For example, in a microscope system using a multiphoton excitation fluorescence microscope, the event detection unit 75 detects an event when it is detected that light has entered a dark room from the image information. For example, in the examination system 13, the event detection unit 75 detects an event when a state such as bleeding or seizure of a patient is detected from image information. For example, feature information indicating the above-described feature is recorded on the recording medium 70 in advance as an event detection condition. The event detection unit 75 extracts the feature information from the image information. The reading unit 80 reads the event detection condition from the recording medium 70. The event detection unit 75 compares the feature information extracted from the image information with the feature information that is the event detection condition read by the reading unit 80. When the feature information extracted from the image information is the same as or similar to the feature information as the event detection condition, the event detection unit 75 detects the event. Thereby, the event detection unit 75 can detect a phenomenon that the observation state indicated by the image information becomes a predetermined state as an event.

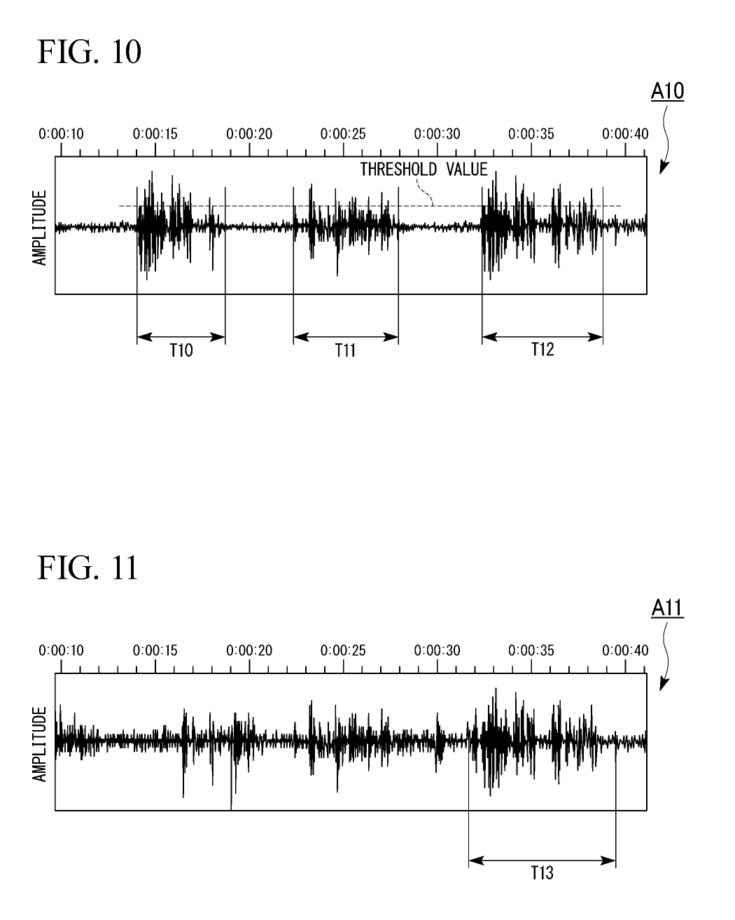

FIGS. 10 and 11 show examples of event detection based on sound information. In FIGS. 10 and 11, the sound information is a time-series sound signal (sound data). The sound signal includes amplitude information of the sound at each of the plurality of time points. FIG. 10 shows a graph of a sound signal A10 and FIG. 11 shows a graph of a sound signal A11. In the graphs of FIGS. 10 and 11, the horizontal direction represents time and the vertical direction represents amplitude.

The sound signal A10 shown in FIG. 10 is a sound during an inspection with an industrial endoscope. For example, the amplitude of the sound signal exceeds a threshold value during a period T10, a period T11, and a period T12 shown in FIG. 10. The threshold value is greater than zero. The user is an inspector. For example, during the period T10, the user utters a sound indicating that there is a scratch at a position of 250 mm. For example, during the period T11, the user utters a sound indicating that there is a hole with a diameter of 5 mm at a position of 320 mm. For example, during the period T12, the user utters a sound indicating that there is rust at a position of 470 mm. When the amplitude of the sound signal exceeds the predetermined threshold value, the event detection unit 75 detects the event. Even when the user has uttered a series of sounds, the sound signal at that time includes a period with small amplitude. When a plurality of events are continuously detected within a predetermined time, the event detection unit 75 may aggregate the plurality of events as one event. Alternatively, the event detection unit 75 may use an average value of amplitudes within a predetermined time as a representative value and detect the presence or absence of an event at predetermined time intervals. In this manner, the event detection unit 75 detects the event during the period T10, the period T11, and the period T12 corresponding to a period during which the user has uttered the sound.

The threshold value may be smaller than zero. If the amplitude of the sound signal is smaller than the threshold value smaller than 0, the amplitude of the sound signal exceeds the threshold value. When the power of the sound signal exceeds a predetermined threshold value, the event detection unit 75 may detect the event. For example, the power of the sound signal is a square mean value of the amplitude.

As described above, the sound acquisition unit 40 acquires sound information based on the sound uttered by the observer who observes the object. The sound information is a time-series sound signal. When the amplitude or the power of the sound signal exceeds the threshold value predefined as the event detection condition, the event detection unit 75 detects the event. For example, a threshold value determined on the basis of amplitude or power of predetermined sound information or a threshold value specified by a user who is the observer is recorded on the recording medium 70 in advance as the event detection condition. The reading unit 80 reads the event detection condition from the recording medium 70. The event detection unit 75 compares the amplitude or power of the sound signal acquired by the sound acquisition unit 40 with the threshold value which is the event detection condition read by the reading unit 80. When the amplitude or the power of the sound signal exceeds the threshold value, the event detection unit 75 detects the event. Thereby, the event detection unit 75 can detect a phenomenon when the user has uttered comments as the event.

The sound signal A11 shown in FIG. 11 is a sound during the inspection with a medical endoscope. The user is a doctor. For example, during the period T13 shown in FIG. 11, the user utters the term “polyp”. When the term “polyp” is registered as a keyword for event detection in advance, the event detection unit 75 detects an event during the period T13.

As described above, the sound acquisition unit 40 acquires sound information based on the sound uttered by the observer who observes the object. When the sound indicated by the sound information is the same as the sound of the keyword predefined as the event detection condition, the event detection unit 75 detects the event. For example, the sound information generated by acquiring the sound of the keyword is recorded on the recording medium 70 in advance as the event detection condition. The reading unit 80 reads the event detection condition from the recording medium 70. The event detection unit 75 compares the sound information acquired by the sound acquisition unit 40 with the sound information that is the event detection condition read by the reading unit 80. For example, when the two pieces of the sound information are the same, i.e., when the similarity between the two pieces of the sound information is greater than or equal to a predetermined value, the event detection unit 75 detects the event. Thereby, the event detection unit 75 can detect a phenomenon when the user who is the observer utters a predetermined keyword as the event.

The event detection unit 75 may detect an event on the basis of text information. As described above, the sound acquisition unit 40 acquires the sound information based on the sound uttered by the observer who observes the object. As described above, the sound processing unit 50 converts the sound information acquired by the sound acquisition unit 40 into the text information. When a keyword indicated by the text information is the same as a keyword predefined as the event detection condition, the event detection unit 75 detects an event. For example, text information of a keyword input by the user who is the observer is recorded on the recording medium 70 in advance as the event detection condition. The reading unit 80 reads the event detection condition from the recording medium 70. The event detection unit 75 compares the text information acquired by the sound processing unit 50 with the text information that is the event detection condition read by the reading unit 80. For example, when the two pieces of the text information are the same, i.e., when the similarity between the two pieces of the text information is greater than or equal to the predetermined value, the event detection unit 75 detects an event.

In the observation site, in many cases, the user recognizes the state of the object or the observation situation and utters comments with respect to the state of the object or the observation situation. Thus, when the event detection unit 75 detects an event on the basis of the sound information or the text information, the event detection unit 75 can more easily detect the event to which the user pays attention.

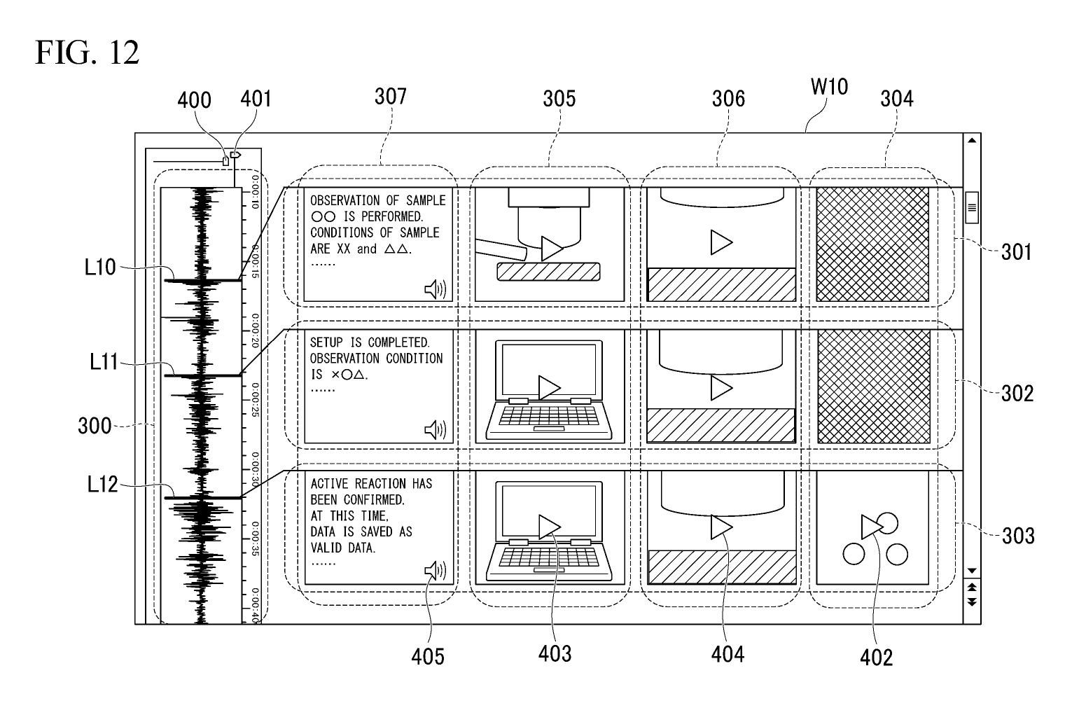

A specific example of display of information by the display unit 90 will be described below. FIG. 12 shows a window W10 displayed on a screen of the display unit 90.

Object information, image information, sound information, and text information associated with the same object are displayed in the window W10. In this example, information in the observation using the microscope is displayed. The sound information is displayed in a region 300 of the window W10. In FIG. 12, the sound information is a time-series sound signal. In a graph of the sound signal displayed in the region 300, the vertical direction represents time and the horizontal direction represents amplitude. A slider bar 400 and a slider bar 401 which are user interfaces for changing a display state of the sound signal are displayed. A user who is a viewer can enlarge or reduce the graph of the sound signal in the amplitude direction by operating the slider bar 400. The user can enlarge or reduce the graph of the sound signal in the time direction by operating the slider bar 401.

Object information, image information, and text information corresponding to the event detected by the event detection unit 75 are displayed in the window W10. The object information, the image information, and the text information are displayed in association with the sound signal. In the sound signal, a line L10, a line L11, and a line L12 are displayed. The line L10, the line L11, and the line L12 show positions on the graph of sound signals corresponding to event occurrence time points. The line L10 corresponds to an event 1. For example, the event 1 occurs at the start of observation. The line L11 corresponds to an event 2. For example, the event 2 occurs at the completion of microscope setup. The line L12 corresponds to an event 3. For example, the event 3 occurs when the object information changes. For example, the event detection unit 75 detects an event at a time point when the amplitude of the sound signal exceeds the threshold value. The object information, the image information, and the text information are displayed in a state associated with the position on the graph corresponding to the event occurrence time point in the sound signal.

The event detection unit 75 detects a plurality of event occurrence time points. The reading unit 80 reads the object information, the image information, and the text information associated with time point information corresponding to each of the plurality of event occurrence time points from the recording medium 70. The display unit 90 displays the object information, the image information, and the text information read by the reading unit 80 at each event occurrence time point such that the object information, the image information, and the text information are associated with each other.

In FIG. 12, object information, image information, and text information corresponding to three events among a plurality of events are shown. Object information, image information, and text information corresponding to the same event are displayed such that the object information, the image information, and the text information are associated with each other. The object information, the image information, and the text information corresponding to the same event are arranged in the horizontal direction. The object information, the image information, and the text information corresponding to the same event are associated by lines parallel to each other in the horizontal direction. The display unit 90 displays the object information, the image information, and the text information associated with the time point information corresponding to the event occurrence time point in association with the position on the graph corresponding to the event occurrence time point in the sound signal. The object information, the image information, and the text information corresponding to the event 1 are displayed in a region 301 of the window W10. The object information, the image information, and the text information corresponding to the event 1 are associated with the line L10 indicating an occurrence time point of the event 1. The object information, the image information, and the text information corresponding to the event 2 are displayed in a region 302 of the window W10. The object information, the image information, and the text information corresponding to the event 2 are associated with the line L11 indicating the occurrence time point of the event 2. The object information, the image information, and the text information corresponding to the event 3 are displayed in a region 303 of the window W10. The object information, the image information, and the text information corresponding to the event 3 are associated with the line L12 indicating the occurrence time point of the event 3.

The object information is an image generated by a camera connected to the microscope. The object information is displayed in a region 304 of the window W10. When the event 1 and the event 2 have occurred, the object information has not yet been acquired. Thus, the object information corresponding to each of the event 1 and the event 2 is not displayed. The image information is displayed in a region 305 and a region 306 of the window W10. Image information generated by the wearable camera worn by the user is displayed in the region 305. The image information generated by the camera photographing the vicinity of the tip of the objective lens of the microscope is displayed in the region 306. Text information is displayed in a region 307 of the window W10.

When the information read by the reading unit 80 includes a plurality of pieces of numerical information in time series, the display unit 90 visualizes the plurality of pieces of numerical information. For example, the plurality of pieces of numerical information constitute a sound signal. The plurality of pieces of numerical information are amplitude or power of the sound signal. The display unit 90 displays the plurality of pieces of numerical information constituting the sound signal as a graph. For example, the plurality of pieces of numerical information constitute a sensor signal acquired by a sensor or a vital sensor. For example, the display unit 90 displays the plurality of pieces of numerical information constituting the sensor signal as a graph.

The sound information is a time-series sound signal. The reading unit 80 reads the sound signal from the recording medium 70. Also, the reading unit 80 reads the object information, the image information, and the text information associated with the time point information corresponding to the event occurrence time point from the recording medium 70. As shown in FIG. 12, the display unit 90 displays the sound signal read by the reading unit 80 in a time-series graph such that a change in the sound signal over time can be visually recognized. The display unit 90 displays the object information, the image information, and the text information read by the reading unit 80 such that the object information, the image information, and the text information are associated with the time-series graph. The display unit 90 displays positions on the time-series graph at time points corresponding to event occurrence time points. For example, as shown in FIG. 12, the display unit 90 displays the lines L10, L11, and L12.

When the object information recorded on the recording medium 70 is divided into a plurality of pieces in a time series, the reading unit 80 reads representative object information associated with the time point information corresponding to the event occurrence time point from the recording medium 70. The display unit 90 displays the representative object information read by the reading unit 80. For example, the object information is image information of the object and the image information of the object is moving-image information. The moving-image information includes image information of a plurality of frames generated at different time points. In this case, the reading unit 80 reads the image information of the object of one frame generated at a time point closest to the event occurrence time point from the recording medium 70. The display unit 90 displays the image information of the object of one frame read by the reading unit 80. A thumbnail of one frame generated at a time point closest to the event occurrence time point may be displayed.

When the image information recorded on the recording medium 70 is divided into a plurality of pieces in a time series, the reading unit 80 reads representative image information associated with the time point information corresponding to the event occurrence time point from the recording medium 70. The display unit 90 displays the representative image information read by the reading unit 80. For example, the image information acquired by the image acquisition unit 30 is moving-image information. As in a case in which the object information is the image information of the object, the reading unit 80 reads the image information of one frame generated at a time point closest to the event occurrence time point from the recording medium 70. The display unit 90 displays the image information of one frame read by the reading unit 80. A thumbnail of one frame generated at the time point closest to the event occurrence time point may be displayed.

When the object information recorded on the recording medium 70 is divided into a plurality of pieces in a time series, the reading unit 80 reads the object information associated with the time point information corresponding to the time point included in an event period corresponding to the event occurrence time point from the recording medium 70. The display unit 90 displays the object information read by the reading unit 80. For example, the object information is image information of the object and the image information of the object is moving-image information. In this case, the reading unit 80 reads image information of the object of a plurality of frames generated during the event period from the recording medium 70. The display unit 90 sequentially displays the image information of the object of the plurality of frames read by the reading unit 80. For example, when the user has operated an icon 402, the display unit 90 displays a moving image of the object during the event period. The event period will be described below.

When the image information recorded on the recording medium 70 is divided into a plurality of pieces in a time series, the reading unit 80 reads image information associated with the time point information corresponding to the time point included in the event period corresponding to the event occurrence time point from the recording medium 70. The display unit 90 displays the image information read by the reading unit 80. For example, the image information acquired by the image acquisition unit 30 is moving-image information. In this case, the reading unit 80 reads the image information of a plurality of frames generated during the event period from the recording medium 70. The display unit 90 sequentially displays the image information of the plurality of frames read by the reading unit 80. For example, when the user has operated an icon 403 or an icon 404, the display unit 90 displays a moving image showing an observation situation during the event period.

As described above, the reading unit 80 reads the sound information associated with the time point information corresponding to the event occurrence time point from the recording medium 70. The sound output unit 100 outputs a sound based on the sound information read by the reading unit 80. For example, the reading unit 80 reads the sound information associated with the time point information corresponding to the time point included in the event period corresponding to the event occurrence time point from the recording medium 70. For example, when the user has operated an icon 405, the sound output unit 100 outputs a sound during the event period.

The sound signal may be displayed such that the horizontal direction in the graph of the sound signal represents time and the vertical direction represents amplitude. In this case, object information, image information, and text information corresponding to the same event are arranged in the vertical direction.

The event period will be described below. The reading unit 80 reads the object information and the image information associated with the time point information corresponding to the time point included in the event period corresponding to the event occurrence time point from the recording medium 70. Also, the reading unit 80 reads the sound information and the text information associated with the time point information corresponding to the time point included in the event period corresponding to the event occurrence time point from the recording medium 70.

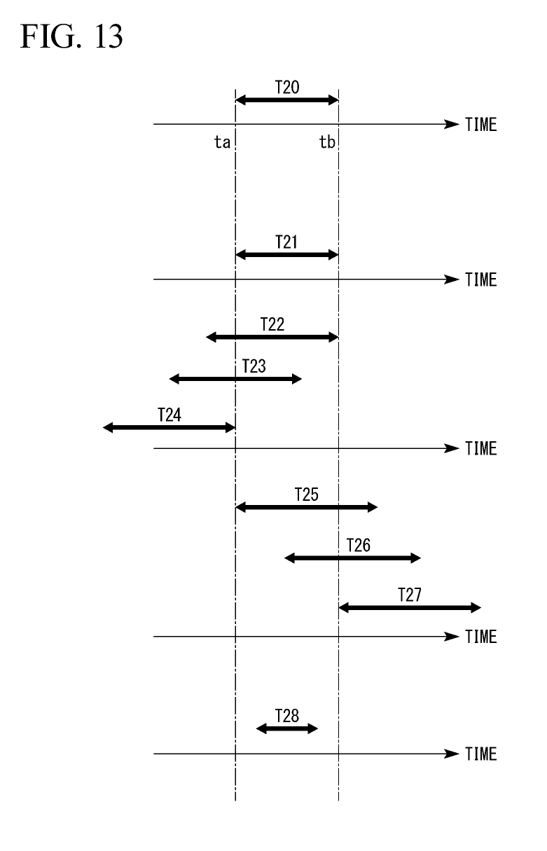

FIG. 13 shows a relationship between the event occurrence time point and the event period. An event occurrence time point T20 is a time point from an event start time ta to an event end time tb. This event continues to occur from the event start time ta to the event end time tb.

An event period T21 is the same as the event occurrence time point T20. An event period T22, an event period T23, and an event period T24 include a time point before the event occurrence time point T20. An end point of the event period T22 is the event end time point tb. An end point of the event period T24 is the event start time point ta. An event period T25, an event period T26, and an event period T27 include a time point later than the event occurrence time point T20. A start point of the event period T25 is the event start time ta. A start point of the event period T27 is the event end time tb. An event period T28 includes only a part of the event occurrence time point. The event period T28 includes only a time point after the event start time to and a time point before the event end time tb.

In the above description, at least one of a time point before the event occurrence time point and a time point after the event occurrence time point may be a preset predetermined time point. Alternatively, at least one of the time points may be a time point relatively set on the basis of the event occurrence time point corresponding to the event period. Also, at least one of the time points may be set on the basis of the event occurrence time point before or after the event corresponding to the event period. The event may continue to be detected consecutively during a certain period of time. Alternatively, the event may be detected in a trigger manner for a short time. In this case, the event occurrence time point is approximately equal to the event end time point. For example, the event period may be a period from a timing that is 5 seconds before an event in which the amplitude of the sound signal exceeds the threshold value is detected to a timing when an event in which an increase of the object in the image of the object is stopped is detected.

The event period is shorter than a period from a first time point to a second time point. The first time point is the earliest time point indicated by the time point information associated with the object information. The second time point is the latest time point indicated by the time point information associated with the object information. When only one event is detected by the event detection unit 75, the event period may be the same as the period from the first time point to the second time point. The event period related to each piece of the image information, the sound information, and the text information is similar to the event period related to the object information.

The event occurrence time point is a timing when the user pays attention. As described above, information corresponding to a predetermined period before or after the event occurrence time point is read from the recording medium 70. Thus, the user can efficiently view information about an event occurring at a timing when the user pays attention.

### First Modified Example of First Embodiment

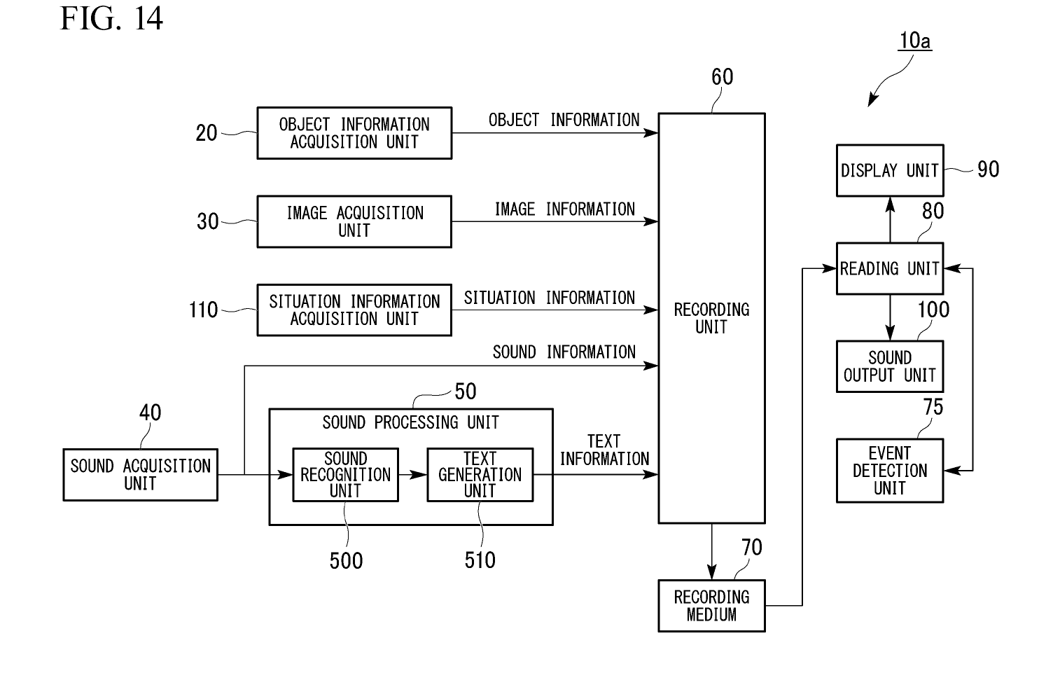

FIG. 14 shows a configuration of an information recording system 10a according to a first modified example of the first embodiment of the present invention. Differences from the configuration shown in FIG. 1 will be described with respect to the configuration shown in FIG. 14.

The information recording system 10a includes a situation information acquisition unit 110 in addition to the configuration of the information recording system 10 shown in FIG. 1. The situation information acquisition unit 110 acquires situation information that indicates a type of situation in which the object information was acquired and is information other than the image information of the object. For example, the situation information is information about at least one of a time point, a place, and a surrounding environment of the object. For example, the surrounding environment of the object indicates conditions such as a temperature, humidity, atmospheric pressure, and illuminance. When the situation information is time point information, the situation information acquisition unit 110 acquires the time point information from a device that generates the time point information. For example, the situation information acquisition unit 110 acquires the time point information from terminals such as a smartphone and a PC. When the situation information is place information, the situation information acquisition unit 110 acquires the place information from a device that generates the place information. For example, the situation information acquisition unit 110 acquires the place information from a terminal such as a smartphone equipped with a Global Positioning System (GPS) function. When the situation information is surrounding environment information, the situation information acquisition unit 110 acquires the surrounding environment information from a device that measures a surrounding environment value. For example, the situation information acquisition unit 110 acquires the surrounding environment information from sensors such as a thermometer, a hygrometer, a barometer, and a luminometer.

The situation information may be device information about a device including an object information acquisition unit 20. The device information may be setting values of the device. For example, in a multiphoton excitation fluorescence microscope, the set values of the device are values such as lens magnification, an amount of observation light, laser power, and a stage position. Additional information such as time point information may be added to the situation information other than the time point information acquired by the situation information acquisition unit 110. For example, the situation information acquisition unit 110 adds the time point information indicating a time point at which the situation information was acquired to the situation information and outputs the situation information to which the time point information is added. When the situation information is time-series information, time point information for identifying a plurality of different time points is added to the situation information. For example, the time point information associated with the situation information includes a time point at which the acquisition of the situation information was started and a sampling rate.

A recording unit 60 may record the object information, the image information, the sound information, the text information, the situation information, and the time point information on a recording medium 70 such that the object information, the image information, the sound information, the text information, the situation information, and the time point information are associated with each other. The time point information indicates time points at which the object information, the image information, the sound information, the text information, and the situation information were acquired. The object information, the image information, the sound information, the text information, and the situation information are associated with each other via the time point information. The situation information may be compressed.

An event detection unit 75 detects an event on the basis of at least one piece of the object information, the image information, the sound information, the text information, and the situation information recorded on the recording medium 70. The event is a state in which the at least one piece of the object information, the image information, the sound information, the text information, and the situation information recorded on the recording medium 70 satisfies a predetermined condition. For example, the at least one piece of the object information, the image information, the sound information, the text information, and the situation information recorded on the recording medium 70 is read by a reading unit 80. The event detection unit 75 detects an event on the basis of the information read by the reading unit 80.

The reading unit 80 reads the object information, the image information, the sound information, the text information, and the situation information associated with the time point information corresponding to the event occurrence time point from the recording medium 70. A display unit 90 displays the object information, the image information, the sound information, the text information, and the situation information read by the reading unit 80 such that the object information, the image information, the sound information, the text information, and the situation information are associated with each other. For example, the display unit 90 simultaneously displays the object information, the image information, the text information, and the situation information. At this time, the display unit 90 displays the object information, the image information, the sound information, the text information, and the situation information in a state in which these pieces of information are arranged. The information selected from the object information, the image information, the sound information, the text information, and the situation information may be displayed on the display unit 90 and the user may be able to switch information to be displayed on the display unit 90. Although the situation information is used for detecting the event, no situation information may be displayed.

In terms of points other than the above, the configuration shown in FIG. 14 is similar to the configuration shown in FIG. 1.

When the situation indicated by the situation information is a state predefined as an event detection condition, the event detection unit 75 detects the event. For example, the situation information is surrounding environment information, i.e., a temperature, acquired from the thermometer. When the temperature indicated by the situation information exceeds a threshold value predefined as the event detection condition, the event detection unit 75 detects the event. For example, a threshold value specified by the user is recorded on the recording medium 70 in advance as the event detection condition. The reading unit 80 reads the event detection condition from the recording medium 70. The event detection unit 75 compares the temperature indicated by the situation information acquired by the situation information acquisition unit 110 with the threshold value that is the event detection condition read by the reading unit 80. When the temperature exceeds the threshold value, the event detection unit 75 detects an event.

When the situation information is recorded, the information recording system 10a can also record other information as information indicating a type of situation in which the object information was acquired in addition to visual information. Thereby, the information recording system 10a can more accurately record an observation situation. Therefore, the user can more accurately reproduce and verify an accurate procedure.

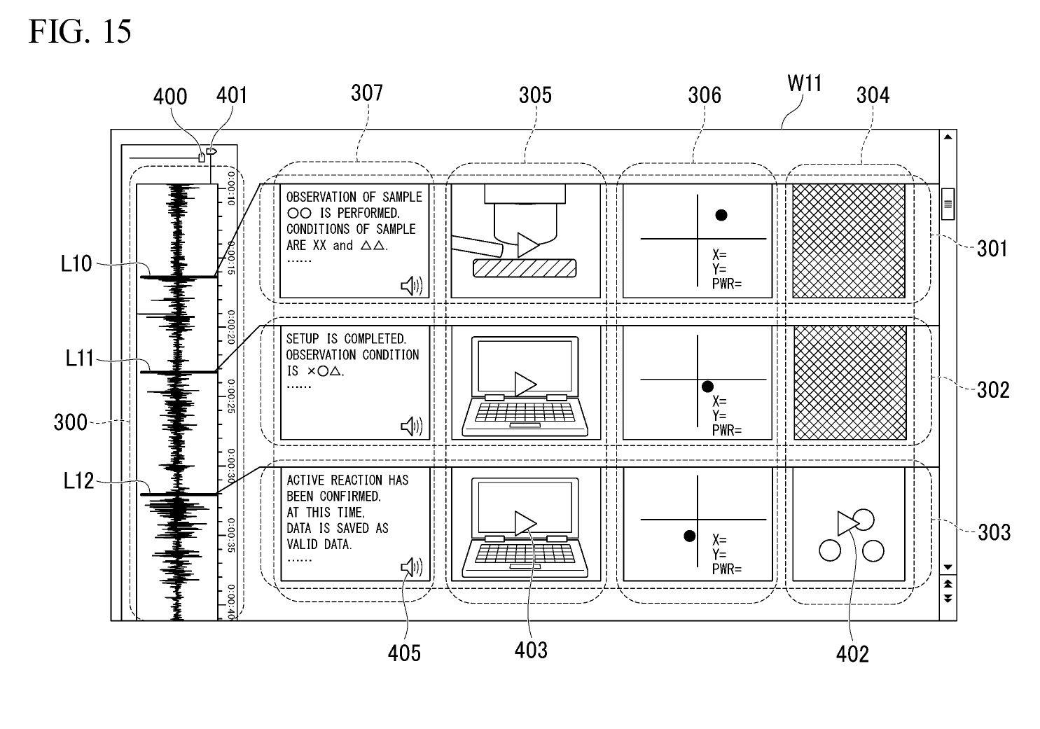

A specific example in which the display unit 90 displays information will be described below. FIG. 15 shows a window W11 displayed on the screen of the display unit 90. In terms of the window W11 shown in FIG. 15, differences from the window W10 shown in FIG. 12 will be described.

In a region 306 shown in FIG. 15, situation information is displayed instead of the image information shown in FIG. 12. The situation information displayed in the region 306 is device information. In the example shown in FIG. 15, the device information is a stage position. The situation information associated with the same object is displayed in the window W11. Also, the situation information corresponding to the event detected by the event detection unit 75 is displayed in the window W11. The situation information is displayed in association with the sound signal. The situation information is displayed in a state associated with the position on a time-series graph corresponding to the event occurrence time point in the sound signal.

When the information read by the reading unit 80 includes a plurality of pieces of numerical information in a time series, the display unit 90 visualizes the plurality of pieces of numerical information. For example, the plurality of pieces of numerical information constitute the situation information. The plurality of pieces of numerical information include a stage position at each time point. The display unit 90 displays the stage position at each time point in a two-dimensional map.

In terms of points other than the above, the window W11 shown in FIG. 15 is similar to the window W10 shown in FIG. 12.

### Second Modified Example of First Embodiment

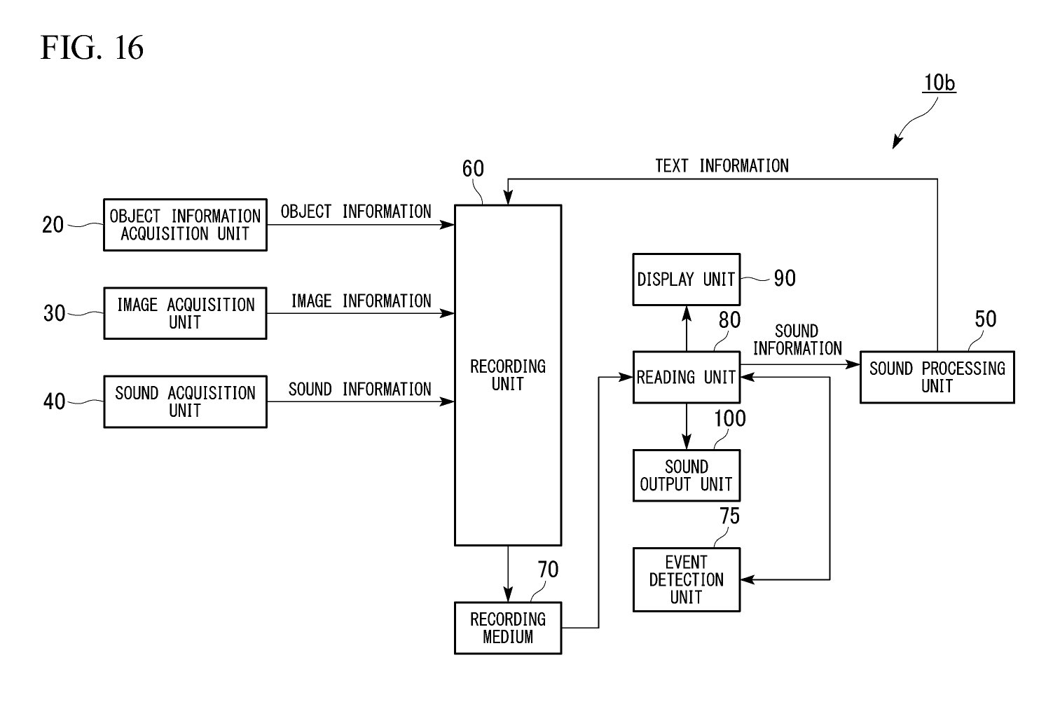

FIG. 16 shows a configuration of an information recording system 10b according to a second modified example of the first embodiment of the present invention. In terms of the configuration shown in FIG. 16, differences from the configuration shown in FIG. 1 will be described.

A recording unit 60 records the object information, the image information, the sound information, and the time point information on a recording medium 70 such that the object information, the image information, the sound information, and the time point information are associated with each other. The time point information indicates time points at which the object information, the image information, and the sound information were acquired. A reading unit 80 reads the sound information from the recording medium 70. The sound processing unit 50 converts the sound information read by the reading unit 80 into text information. The recording unit 60 associates the text information with the object information, the image information, and the sound information recorded on the recording medium 70 and records the text information on the recording medium 70. The time point information of the text information indicates time point at which the original sound information was acquired. An event detection unit 75 detects an event on the basis of at least one piece of the object information, the image information, and the text information recorded on the recording medium 70. The event is a state in which the at least one piece of the object information, the image information, and the text information recorded on the recording medium 70 satisfies a predetermined condition.

In terms of points other than the above, the configuration shown in FIG. 16 is similar to the configuration shown in FIG. 1.

In the information recording system 10b, sound processing is performed by a sound processing unit 50 after the entire sound information is recorded on the recording medium 70. Generally, the load of sound processing is high. Even when a sound processing rate is slower than a sound information acquisition rate, the information recording system 10b can record the text information.

### Third Modified Example of First Embodiment

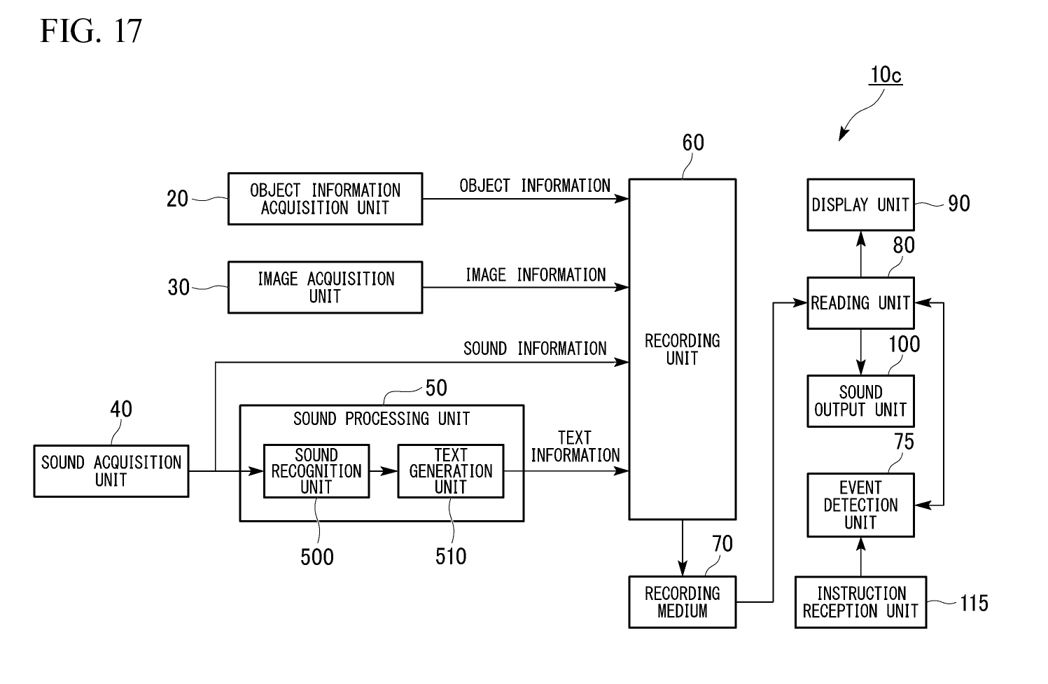

FIG. 17 shows a configuration of an information recording system 10c according to a third modified example of the first embodiment of the present invention. In terms of the configuration shown in FIG. 17, differences from the configuration shown in FIG. 1 will be described.

The information recording system 10c includes an instruction reception unit 115 in addition to the configuration of the information recording system 10 shown in FIG. 1. The instruction reception unit 115 receives an event selection instruction for selecting any one of events detected by an event detection unit 75. For example, the instruction reception unit 115 is configured as an operation unit. The instruction reception unit 115 may be configured as a communication unit that wirelessly communicates with the operation unit. The user inputs the event selection instruction via the instruction reception unit 115. A reading unit 80 reads the object information and the image information associated with the time point information corresponding to the event occurrence time point of the selected event from a recording medium 70. The selected event is an event corresponding to the event selection instruction received by the instruction reception unit 115. A display unit 90 displays the object information and the image information read by the reading unit 80 such that the object information and the image information are associated with each other. That is, the display unit 90 displays the object information and the image information corresponding to the selected event such that the object information and the image information are associated with each other.

The display unit 90 displays only the object information and the image information associated with the time point information corresponding to the event occurrence time point of the selected event among the object information and the image information associated with the time point information corresponding to event occurrence time points of events detected by the event detection unit 75. For example, when a plurality of events are detected by the event detection unit 75, the display unit 90 displays only the object information and the image information associated with the time point information corresponding to event occurrence time points of one or more selected events among the plurality of events. The display unit 90 may more emphasize and display the object information and the image information associated with the time point information corresponding to the event occurrence time point of the selected event among the object information and the image information associated with the time point information corresponding to event occurrence time points of events detected by the event detection unit 75.

As described above, a sound acquisition unit 40 acquires sound information based on the sound uttered by the observer who observes the object. The sound information is a time-series sound signal. A recording unit 60 records the object information, the image information, the sound signal, and the time point information on the recording medium 70 such that the object information, the image information, the sound signal, and the time point information are associated with each other. The time point information indicates time points at which the object information, the image information, and the sound signal were acquired. The reading unit 80 reads the sound signal from the recording medium 70 and reads the object information and the image information associated with the time point information corresponding to the event occurrence time point of the selected event from the recording medium 70. The display unit 90 displays the sound signal read by the reading unit 80 on a time-series graph such that a change in the sound signal over time can be visually recognized. The display unit 90 displays the object information and the image information read by the reading unit 80 such that the object information and the image information are associated with the time-series graph. The display unit 90 displays a position on the time-series graph at the time point corresponding to the event occurrence time point of the selected event.

When an event position has been specified in the sound signal displayed by the display unit 90, the instruction reception unit 115 receives an event selection instruction. The event position is a position corresponding to the event occurrence time point of the selected event. For example, a user who is a viewer inputs an instruction for specifying the event position via the instruction reception unit 115. The instruction reception unit 115 receives the instruction for specifying the event position as an event selection instruction. After the event selection instruction is received by the instruction reception unit 115, the display unit 90 displays the object information and the image information read by the reading unit 80 such that the object information and the image information are associated with the time-series graph.

In terms of points other than the above, the configuration shown in FIG. 17 is similar to the configuration shown in FIG. 1.

In the information recording system 10c, the object information and the image information associated with the selected event corresponding to the event selection instruction are displayed. Thus, the user can efficiently view information about an event occurring at a timing when the user pays attention.

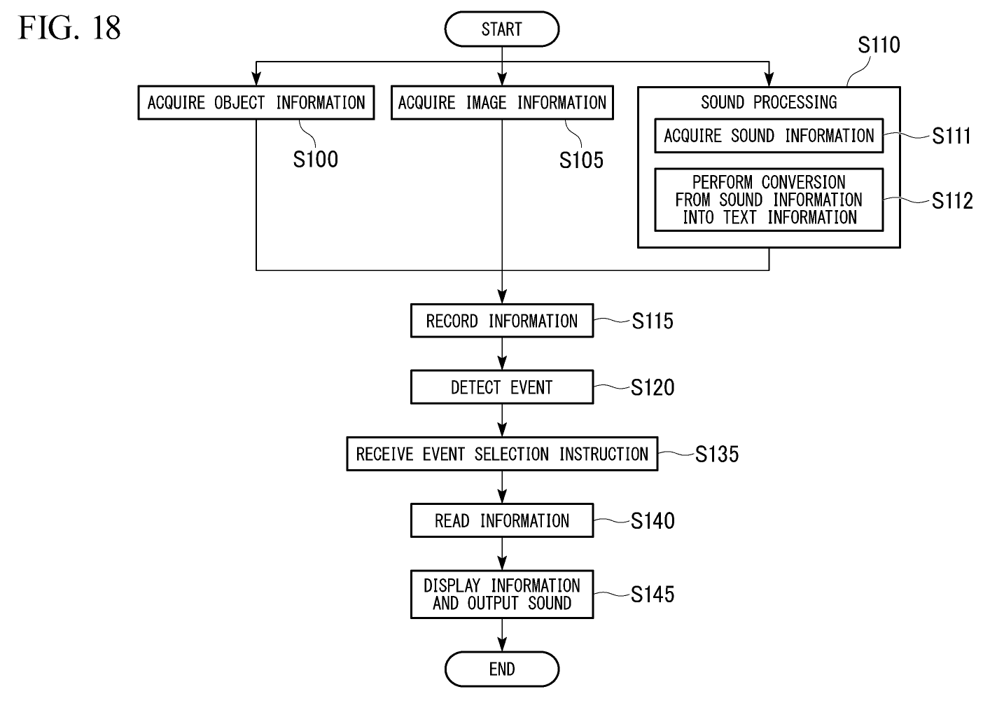

FIG. 18 shows a procedure of processing of the information recording system 10c. In terms of the processing shown in FIG. 18, differences from the processing shown in FIG. 2 will be described.

After step S120, the instruction reception unit 115 receives an event selection instruction for selecting any one of events detected by the event detection unit 75 in step S120 (step S135 (an instruction reception step)). The selected event is selected according to the event selection instruction.

After step S135, the reading unit 80 reads object information, image information, sound information, and text information associated with time point information corresponding to an event occurrence time point of the selected event from the recording medium 70 (step S140 (a reading step)).

After step S140, the display unit 90 displays the object information, the image information, and the text information read by the reading unit 80 such that the object information, the image information, and the text information are associated with each other. That is, the display unit 90 displays the object information, the image information, and the text information corresponding to the selected event such that the object information, the image information, and the text information are associated with each other. Also, a sound output unit 100 outputs a sound based on sound information read by the reading unit 80. That is, the sound output unit 100 outputs a sound based on the sound information corresponding to the selected event (step S145 (a display step and a sound output step)).

In terms of points other than the above, the processing shown in FIG. 18 is similar to the processing shown in FIG. 2.

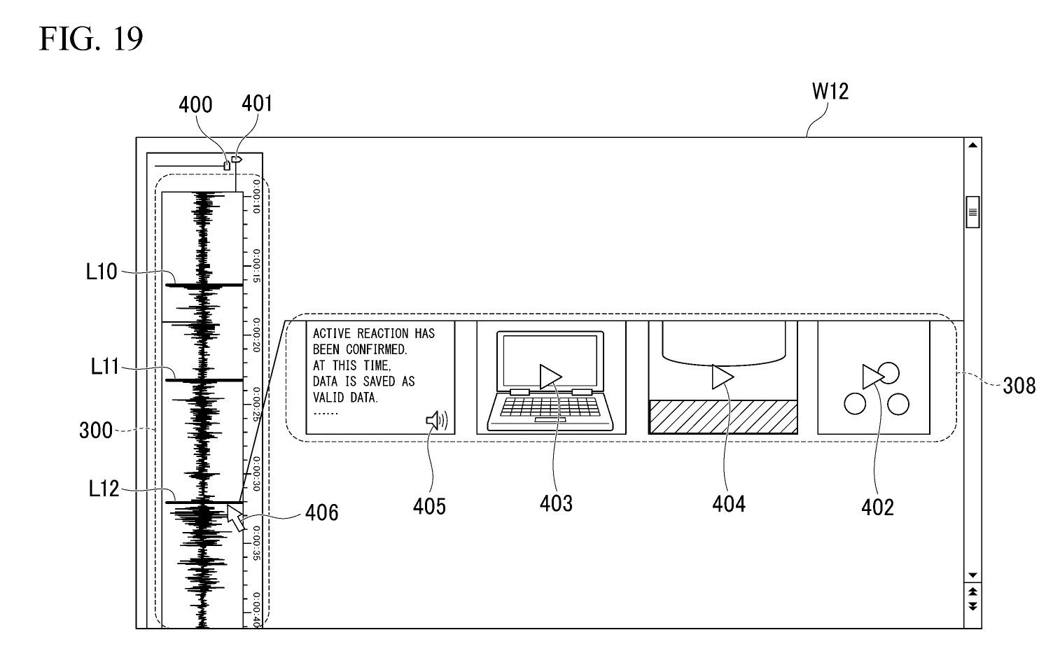

FIG. 19 shows a window W12 displayed on a screen of the display unit 90. In terms of the window W12 shown in FIG. 19, differences from the window W10 shown in FIG. 12 will be described.

The reading unit 80 reads the sound information from the recording medium 70. The display unit 90 displays the sound information read by the reading unit 80. The display unit 90 displays the sound information as a sound signal such that a change in the sound information over time can be visually recognized. The sound signal is displayed in a region 300 and a line L10, a line L11, and a line L12 indicating event positions are displayed on the sound signal. At this time, the object information, the image information, and the text information are not displayed. Also, an icon 406 for allowing the user to specify an event position is displayed on the window W12. The user moves the icon 406 via the instruction reception unit 115. The icon 406 is displayed at the position specified by the user via the instruction reception unit 115.

When the icon 406 overlaps any one of the line L10, the line L11, and the line L12, the user inputs an event selection instruction via the instruction reception unit 115. At this time, the instruction reception unit 115 receives the event selection instruction. An event corresponding to a line overlapping the icon 406 when the event selection instruction has been received is a selected event. For example, as shown in FIG. 19, when the icon 406 overlaps the line L12, the user inputs the event selection instruction via the instruction reception unit 115. Thereby, the event 3 corresponding to the line L12 is selected as the selected event. At this time, the reading unit 80 reads object information, image information, sound information, and text information associated with time point information corresponding to an event occurrence time point of the selected event, i.e., the event 3, from the recording medium 70.

The display unit 90 displays the object information, the image information, and the text information read by the reading unit 80. The object information, the image information, and the text information corresponding to the event 3 are displayed in a region 308 of the window W12. The object information, the image information, and the text information corresponding to the event 3 are associated with the line L12 indicating the occurrence time point of the event 3. The display unit 90 may enlarge and display the object information, the image information, and the text information read by the reading unit 80. When the user has operated an icon 405, the sound output unit 100 outputs a sound during an event period corresponding to the event 3.

After the instruction reception unit 115 receives a first event selection instruction, the instruction reception unit 115 may receive a second event selection instruction different from the first event selection instruction. For example, as described above, after the user inputs the event selection instruction corresponding to the event 3, the user may input an event selection instruction corresponding to the event 1. That is, the user causes the icon 406 to be moved from the position of the line L12 to the position of the line L10 via the instruction reception unit 115. When the icon 406 overlaps the line L10, the user inputs the event selection instruction via the instruction reception unit 115. Thereby, the event 1 is selected as the selected event. When the instruction reception unit 115 has received the second event selection instruction, the display unit 90 hides the object information, the image information, and the text information associated with the first selected event corresponding to the first event selection instruction. That is, the display unit 90 hides the object information, the image information, and the text information corresponding to the event 3.

The reading unit 80 reads the object information, the image information, and the text information associated with the time point information corresponding to the event occurrence time point of the second selected event from the recording medium 70. The second selected event is an event corresponding to the second event selection instruction. After the display unit 90 hides the object information, the image information, and the text information associated with the first selected event corresponding to the first event selection instruction, the display unit 90 displays the object information, the image information, and the text information associated with the second selected event. That is, the display unit 90 displays the object information, the image information, and the text information corresponding to the event 1.

In terms of points other than the above, the window W12 shown in FIG. 19 is similar to the window W10 shown in FIG. 12.

In the window W10 shown in FIG. 12 or the window W11 shown in FIG. 15, the display unit 90 may more emphasize and display the object information and the image information associated with the time point information corresponding to the event occurrence time point of the selected event. For example, when the event 3 has been selected as the selected event, the display unit 90 displays information corresponding to the event 3 such that the information corresponding to the event 3 is emphasized more than the information corresponding to the event 1 and the event 2. For example, the display unit 90 displays a line associated with the information corresponding to the selected event such that the line is thicker than a line associated with an event other than the selected event. The display unit 90 may display the information corresponding to the selected event such that the information corresponding to the selected event is larger than information corresponding to an event other than the selected event.

### Second Embodiment

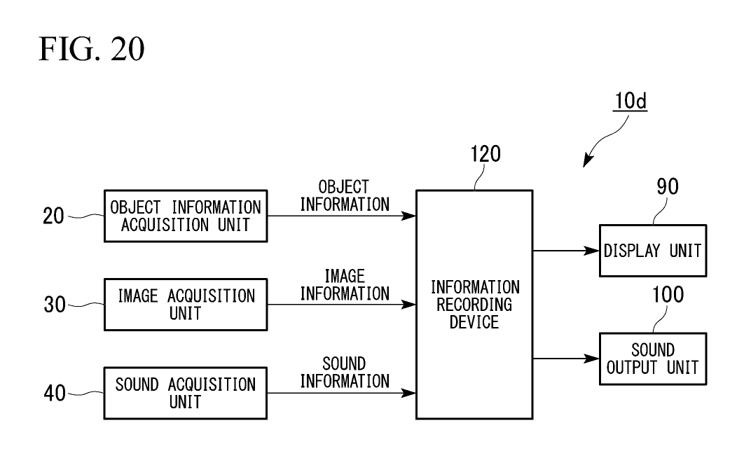

FIG. 20 shows a configuration of an information recording system 10d according to a second embodiment of the present invention. In terms of the configuration shown in FIG. 20, differences from the configuration shown in FIG. 1 will be described.

As shown in FIG. 20, the information recording system 10d includes an object information acquisition unit 20, an image acquisition unit 30, a sound acquisition unit 40, an information recording device 120, a display unit 90, and a sound output unit 100. Configurations of the object information acquisition unit 20, the image acquisition unit 30, the sound acquisition unit 40, the display unit 90, and the sound output unit 100 are similar to those corresponding to the components shown in FIG. 1. In the information recording system 10d shown in FIG. 20, the sound processing unit 50, the recording unit 60, the recording medium 70, the event detection unit 75, and the reading unit 80 in the information recording system 10 shown in FIG. 1 are changed to the information recording device 120.

In terms of points other than the above, the configuration shown in FIG. 20 is similar to the configuration shown in FIG. 1.

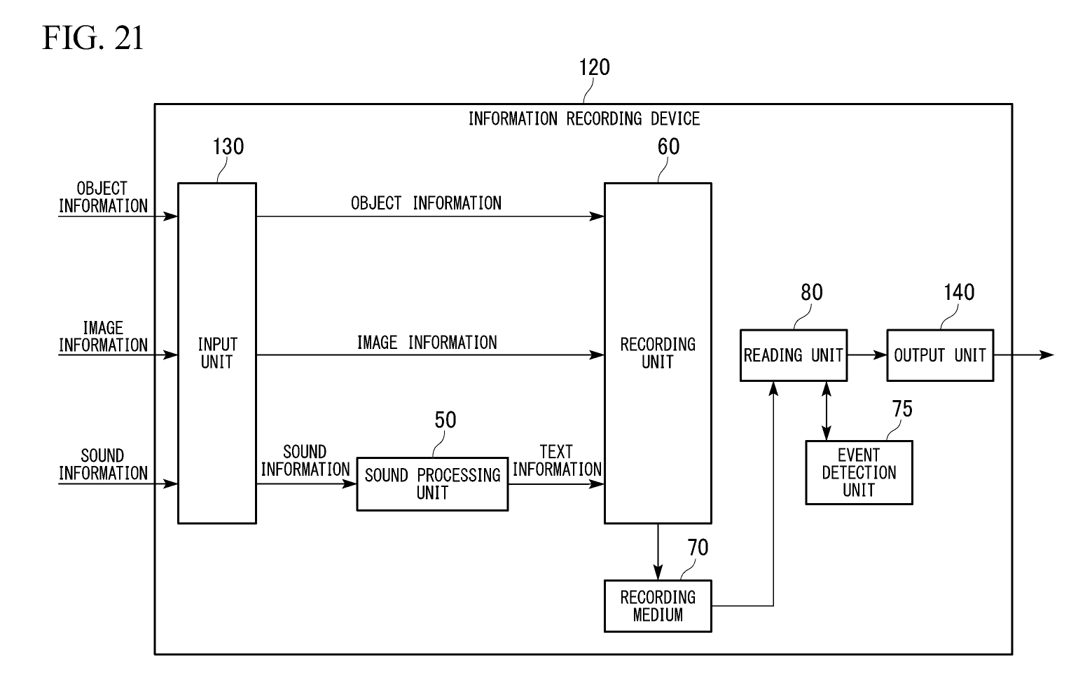

FIG. 21 shows a configuration of the information recording device 120. As shown in FIG. 21, the information recording device 120 includes a sound processing unit 50, a recording unit 60, a recording medium 70, an event detection unit 75, a reading unit 80, an input unit 130, and an output unit 140.

The configurations of the sound processing unit 50, the recording unit 60, the recording medium 70, the event detection unit 75, and the reading unit 80 are similar to those corresponding to the components shown in FIG. 1. Object information from the object information acquisition unit 20, image information from the image acquisition unit 30, and sound information from the sound acquisition unit 40 are input to the input unit 130. For example, at least one of the object information acquisition unit 20, the image acquisition unit 30, and the sound acquisition unit 40 is connected to the information recording device 120 through a cable. In this case, the input unit 130 is an input terminal to which the cable is connected. At least one of the object information acquisition unit 20, the image acquisition unit 30, and the sound acquisition unit 40 may be wirelessly connected to the information recording device 120. In this case, the input unit 130 is a wireless communication circuit that wirelessly communicates with at least one of the object information acquisition unit 20, the image acquisition unit 30, and the sound acquisition unit 40.

The output unit 140 outputs the object information, the image information, the sound information, and the text information read by the reading unit 80. That is, the output unit 140 outputs the object information, the image information, the sound information, and the text information to the display unit 90 and outputs the sound information to the sound output unit 100. For example, at least one of the display unit 90 and the sound output unit 100 is connected to the information recording device 120 through a cable. In this case, the output unit 140 is an output terminal to which the cable is connected. At least one of the display unit 90 and the sound output unit 100 may be wirelessly connected to the information recording device 120. In this case, the output unit 140 is a wireless communication circuit that wirelessly communicates with at least one of the display unit 90 and the sound output unit 100.

The information recording device 120 may read a program and execute the read program. That is, the function of the information recording device 120 may be implemented by software. This program includes instructions for defining the operations of the sound processing unit 50, the recording unit 60, the event detection unit 75, and the reading unit 80. For example, this program may be provided by a “computer-readable recording medium” such as a flash memory. Also, the above-described program may be transmitted from a computer having a storage device or the like in which the program is stored to the information recording device 120 via a transmission medium or transmission waves in the transmission medium. The “transmission medium” for transmitting the program refers to a medium having an information transmission function, for example, a network (a communication network) such as the Internet or a communication circuit (a communication line) such as a telephone circuit. Also, the above-described program may be a program for implementing some of the above-described functions. Further, the above-described program may be a program capable of implementing the above-described function in combination with a program already recorded on the computer, i.e., a so-called differential file (differential program).

Various modifications applied to the information recording system 10 shown in FIG. 1 may be similarly applied to the information recording system 10d shown in FIG. 20. For example, the information recording system 10d may not include the sound acquisition unit 40, the sound processing unit 50, and the sound output unit 100. In this case, object information and image information are input to the input unit 130. The recording unit 60 records the object information, the image information, and time point information on the recording medium 70 such that the object information, the image information, and the time point information are associated with each other. The event detection unit 75 detects an event on the basis of at least one piece of the object information and the image information recorded on the recording medium 70. The reading unit 80 reads the object information and the image information associated with the time point information corresponding to an event occurrence time point from the recording medium 70. The output unit 140 outputs the object information and the image information read by the reading unit 80. The display unit 90 displays the object information and the image information output by the output unit 140 such that the object information and the image information are associated with each other.

The information recording system 10d may not include the sound processing unit 50. In this case, the object information, the image information, and the sound information are input to the input unit 130. The recording unit 60 records the object information, the image information, the sound information, and the time point information on the recording medium 70 such that the object information, the image information, the sound information, and the time point information are associated with each other. The event detection unit 75 detects an event on the basis of at least one piece of the object information, the image information, and the sound information recorded on the recording medium 70. The reading unit 80 reads the object information, the image information, and the sound information associated with the time point information corresponding to an event occurrence time point from the recording medium 70. The output unit 140 outputs the object information, the image information, and the sound information read by the reading unit 80. The display unit 90 displays the object information, the image information, and the sound information output by the output unit 140 such that the object information, the image information, and the sound information are associated with each other. The sound output unit 100 outputs a sound based on the sound information output by the output unit 140. Although the sound information is used for detecting the event, no sound information may be output from the information recording device 120.

The information recording system 10d does not include the sound output unit 100 and the recording unit 60 may not record sound information. In this case, the object information, the image information, and the sound information are input to the input unit 130. The recording unit 60 records the object information, the image information, the text information, and the time point information on the recording medium 70 such that the object information, the image information, the text information, and the time point information are associated with each other. The event detection unit 75 detects an event on the basis of at least one piece of the object information, the image information, and the text information recorded on the recording medium 70. The reading unit 80 reads the object information, the image information, and the text information associated with the time point information corresponding to an event occurrence time point from the recording medium 70. The output unit 140 outputs the object information, the image information, and the text information read by the reading unit 80. The display unit 90 displays the object information, the image information, and the text information output by the output unit 140 such that the object information, the image information, and the text information are associated with each other. Although the text information is used for detecting the event, no text information may be output from the information recording device 120.

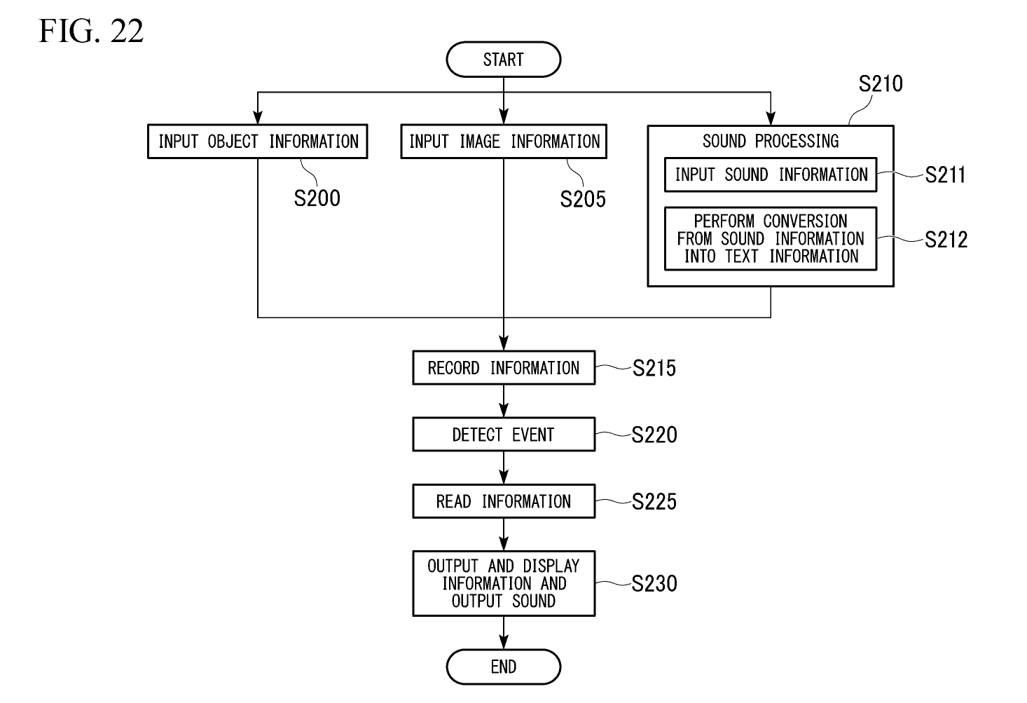

FIG. 22 shows a procedure of processing of the information recording device 120. The procedure of processing of the information recording device 120 will be described with reference to FIG. 22.

Object information about the object is input to the input unit 130 (step S200 (an input step)). The object information input in step S200 is stored in the buffer within the recording unit 60. In parallel with the input of the object information to the input unit 130, image information indicating a type of situation in which the object information was acquired is input to the input unit 130 (step S205 (an input step)). The image information input in step S205 is stored in the buffer within the recording unit 60. In parallel with the input of the object information to the input unit 130, the processing in step S210 is performed. Step S210 includes step S211 (a sound input step) and step S212 (a sound processing step). In step S211, sound information based on a sound uttered by an observer who observes the object is input to the input unit 130. In step S212, the sound processing unit 50 converts the sound information input to the input unit 130 into text information. In step S210, the processing in steps S211 and S212 is iterated. The sound information input in step S211 and the text information generated in step S212 are stored in the buffer within the recording unit 60.

Processing start timings of step S200, step S205, and step S210 may not be the same. Processing end timings of step S200, step S205, and step S210 may not be the same. At least some of periods during which the processing in step S200, step S205, and step S210 is performed overlap each other.

After the input of the object information, the image information, and the sound information is completed, the recording unit 60 records the object information, the image information, the sound information, the text information, and the time point information stored in the buffer within the recording unit 60 on the recording medium 70 such that the object information, the image information, the sound information, the text information, and the time point information are associated with each other (step S215 (a recording step)).

After step S215, the event detection unit 75 detects an event on the basis of at least one piece of the object information, the image information, the sound information, and the text information recorded on the recording medium 70 (step S220 (an event detection step)).

After step S220, the reading unit 80 reads the object information, the image information, the sound information, and the text information associated with the time point information corresponding to an event occurrence time point that is a time point at which an event occurred from the recording medium 70 (step S225 (a reading step)). The user may be able to specify a timing at which the information is read.

After step S225, the output unit 140 outputs the object information, the image information, the sound information, and the text information read by the reading unit 80. The display unit 90 displays the object information, the image information, the sound information, and the text information output by the output unit 140 such that the object information, the image information, the sound information, and the text information are associated with each other. Also, the sound output unit 100 outputs a sound based on the sound information output by the output unit 140 (step S230 (an output step, a display step, and a sound output step)).

When the information recording system 10d does not include the sound acquisition unit 40 and the sound processing unit 50, the processing in step S210 is not performed. Also, in step S215, the recording unit 60 records the object information, the image information, and the time point information on the recording medium 70 such that the object information, the image information, and the time point information are associated with each other. In step S220, the event detection unit 75 detects an event on the basis of at least one piece of the object information and the image information recorded on the recording medium 70. In step S225, the reading unit 80 reads the object information and the image information associated with the time point information corresponding to the event occurrence time point from the recording medium 70. In step S230, the output unit 140 outputs the object information and the image information read by the reading unit 80. Also, in step S230, the display unit 90 displays the object information and the image information output by the output unit 140 such that the object information and the image information are associated with each other.

When the information recording system 10d does not include the sound processing unit 50, the processing in step S212 is not performed. Also, in step S215, the recording unit 60 records the object information, the image information, the sound information, and the time point information on the recording medium 70 such that the object information, the image information, the sound information, and the time point information are associated with each other. In step S220, the event detection unit 75 detects an event on the basis of at least one piece of the object information, the image information, and the sound information recorded on the recording medium 70. In step S225, the reading unit 80 reads the object information, the image information, and the sound information associated with the time point information corresponding to the event occurrence time point from the recording medium 70. In step S230, the output unit 140 outputs the object information, the image information, and the sound information read by the reading unit 80 in step S225. Also, in step S230, the display unit 90 displays the object information, the image information, and the sound information output by the output unit 140 such that the object information, the image information, and the sound information are associated with each other. Also, in step S230, the sound output unit 100 outputs a sound based on the sound information output by the output unit 140. Although the sound information is used for detecting the event, no sound information may be output from the information recording device 120.

When the information recording system 10d does not include the sound output unit 100 and the recording unit 60 does not record sound information, the recording unit 60 records the object information, the image information, the text information, and the time point information on the recording medium 70 such that the object information, the image information, the text information, and the time point information are associated with each other in step S215. In step S220, the event detection unit 75 detects an event on the basis of at least one piece of the object information, the image information, and the text information recorded on the recording medium 70. In step S225, the reading unit 80 reads the object information, the image information, and the text information associated with the time point information corresponding to the event occurrence time point from the recording medium 70. In step S230, the output unit 140 outputs the object information, the image information, and the text information read by the reading unit 80 in step S225. Also, in step S230, the display unit 90 displays the object information, the image information, and the text information output by the output unit 140 such that the object information, the image information, and the text information are associated with each other. Although the text information is used for detecting the event, no text information may be output from the information recording device 120.

At least one of the sound processing unit 50 and the recording medium 70 may be disposed outside the information recording device 120. When the sound processing unit 50 is disposed outside the information recording device 120, the text information from the sound processing unit 50 is input to the input unit 130. The recording medium 70 may be attachable to and detachable from the information recording device 120. The information recording device 120 may have a network interface and the information recording device 120 may be connected to the recording medium 70 via a network. The information recording device 120 may have a wireless communication interface and the information recording device 120 may be connected to the recording medium 70 through wireless communication.

The information recording device 120 may not include the output unit 140. For example, the recording medium 70 is configured such that the recording medium 70 can be attached to or detached from the information recording device 120. The reading unit 80 reads the object information, the image information, the sound information, and the text information associated with the time point information corresponding to the event occurrence time point recognized by the event detection unit 75 from the recording medium 70. The recording unit 60 records the object information, the image information, the sound information, and the text information read by the reading unit 80 on the recording medium 70 such that the object information, the image information, the sound information, and the text information are associated with each other. When the recording medium 70 is detached from the information recording device 120 and is attached to a device outside the information recording device 120, the device can use the information recorded on the recording medium 70. When the information recording device 120 does not include the output unit 140, the information recording device 120 does not perform the processing in step S230.

As described above, object information is input to the input unit 130 and image information indicating a type of situation in which the object information was acquired is input to the input unit 130. The input object information and image information are recorded on the recording medium 70 by the recording unit 60. Thereby, the information recording device 120 can record visual information indicating a type of situation in which the object information was acquired.

As described above, an event is detected on the basis of at least one piece of the object information and the image information recorded on the recording medium 70 and the object information and the image information corresponding to the event occurrence time point are displayed such that the object information and the image information are associated with each other. Thereby, the information recording device 120 can support efficient information viewing by the user. An effect obtained in the information recording system 10 of the first embodiment can be similarly obtained also in the information recording device 120 of the second embodiment.

In each of the systems shown in FIGS. 3 to 7, parts corresponding to the sound processing unit 50, the recording unit 60, the recording medium 70, the event detection unit 75, and the reading unit 80 may be changed to a configuration corresponding to the information recording device 120. The matters disclosed in the first to third modified examples of the first embodiment may be similarly applied to the information recording device 120 of the second embodiment. Therefore, the information recording system 10d may include the situation information acquisition unit 110 and the situation information acquired by the situation information acquisition unit 110 may be input to the input unit 130. Alternatively, the information recording system 10d may include the instruction reception unit 115 and an event selection instruction received by the instruction reception unit 115 may be input to the input unit 130.

### Supplement

According to an aspect of the present invention, an information recording method includes an input step, a recording step, an event detection step, and a reading step. In the input step, object information acquired by an object information acquisition unit and image information indicating a situation in which the object information was acquired by the object information acquisition unit are input to an input unit. The object information is information about an object. In the recording step, a recording unit records the object information, the image information, and time point information on a recording medium such that the object information, the image information, and the time point information are associated with each other. The time point information indicates a time point at which the object information was acquired and a time point at which the image information was acquired. In the event detection step, an event detection unit detects an event on the basis of at least one piece of the object information and the image information recorded on the recording medium. The event is a state in which the at least one piece of the object information and the image information recorded on the recording medium satisfies a predetermined condition. In the reading step, a reading unit reads the object information and the image information that are associated with the time point information corresponding to an event occurrence time point that is a time point at which the event occurred from the recording medium.

While preferred embodiments of the invention have been described and shown above, it should be understood that these are exemplars of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An information recording system comprising:
an object information acquisition unit configured to acquire object information about an object;
an image acquisition unit configured to acquire image information indicating a situation in which the object information was acquired by the object information acquisition unit;
a recording unit configured to record the object information, the image information, and time point information on a recording medium such that the object information, the image information, and the time point information are associated with each other, the time point information indicating a time point at which the object information was acquired and a time point at which the image information was acquired;
an event detection unit configured to detect an event on the basis of at least one piece of the object information and the image information, the event being a state in which the at least one piece of the object information and the image information recorded on the recording medium satisfies a predetermined condition;
a reading unit configured to read the object information and the image information that are associated with the time point information corresponding to an event occurrence time point that is a time point at which the event occurred from the recording medium; and
a display unit configured to display the object information and the image information read by the reading unit such that the object information and the image information are associated with each other.

2. The information recording system according to claim 1, further comprising a situation information acquisition unit configured to acquire situation information that indicates a type of situation in which the object information was acquired and is information other than the image information of the object,
wherein the recording unit records the object information, the image information, the situation information, and the time point information on the recording medium such that the object information, the image information, the situation information, and the time point information are associated with each other, the time point information indicating a time point at which the object information was acquired, a time point at which the image information was acquired, and a time point at which the situation information was acquired, and
the event detection unit detects the event on the basis of at least one piece of the object information, the image information, and the situation information recorded on the recording medium, the event being a state in which the at least one piece of the object information, the image information, and the situation information recorded on the recording medium satisfies a predetermined condition.

3. The information recording system according to claim 1, further comprising a sound acquisition unit configured to acquire sound information based on a sound uttered by an observer who observes the object,
wherein the recording unit records the object information, the image information, the sound information, and the time point information on the recording medium such that the object information, the image information, the sound information, and the time point information are associated with each other, the time point information indicating a time point at which the object information was acquired, a time point at which the image information was acquired, and a time point at which the sound information was acquired, and
the event detection unit detects the event on the basis of at least one piece of the object information, the image information, and the sound information recorded on the recording medium, the event being a state in which the at least one piece of the object information, the image information, and the sound information recorded on the recording medium satisfies a predetermined condition.

4. The information recording system according to claim 3,
wherein the sound information is a time-series sound signal,
the reading unit reads the sound signal from the recording medium and reads the object information and the image information that are associated with the time point information corresponding to the event occurrence time point from the recording medium,
the display unit displays the sound signal read by the reading unit in a time-series graph such that a change in the sound signal over time is able to be visually recognized,
the display unit displays the object information and the image information read by the reading unit such that the object information and the image information are associated with the time-series graph, and
the display unit displays a position on the time-series graph at a time point corresponding to the event occurrence time point.

5. The information recording system according to claim 1, further comprising:
a sound acquisition unit configured to acquire sound information based on a sound uttered by an observer who observes the object; and
a sound processing unit configured to convert the sound information acquired by the sound acquisition unit into text information,
wherein the recording unit records the object information, the image information, the text information, and the time point information on the recording medium such that the object information, the image information, the text information, and the time point information are associated with each other, the time point information indicating a time point at which the object information was acquired, a time point at which the image information was acquired, and a time point at which the sound information that is a source of the text information was acquired, and
the event detection unit detects the event on the basis of at least one piece of the object information, the image information, and the text information recorded on the recording medium, the event being a state in which the at least one piece of the object information, the image information, and the text information recorded on the recording medium satisfies a predetermined condition.

6. The information recording system according to claim 1, further comprising:
a sound acquisition unit configured to acquire sound information based on a sound uttered by an observer who observes the object; and
a sound processing unit,
wherein the recording unit records the object information, the image information, the sound information, and the time point information on the recording medium such that the object information, the image information, the sound information, and the time point information are associated with each other, the time point information indicating a time point at which the object information was acquired, a time point at which the image information was acquired, and a time point at which the sound information was acquired,
the reading unit reads the sound information from the recording medium,
the sound processing unit converts the sound information read by the reading unit into text information,
the recording unit associates the text information with the object information, the image information, and the time point information recorded on the recording medium and records the text information on the recording medium, the time point information with which the text information is associated indicates a time point at which the sound information that is a source of the text information was acquired, and
the event detection unit detects the event on the basis of at least one piece of the object information, the image information, and the text information recorded on the recording medium, the event being a state in which the at least one piece of the object information, the image information, and the text information recorded on the recording medium satisfies a predetermined condition.

7. The information recording system according to claim 1, further comprising an instruction reception unit configured to receive an event selection instruction for selecting any one of events detected by the event detection unit,
wherein the reading unit reads the object information and the image information that are associated with the time point information corresponding to the event occurrence time point of the selected event from the recording medium, the selected event being the event corresponding to the event selection instruction received by the instruction reception unit.

8. The information recording system according to claim 7, further comprising a sound acquisition unit configured to acquire sound information based on a sound uttered by an observer who observes the object, the sound information being a time-series sound signal,
wherein the recording unit records the object information, the image information, the sound signal, and the time point information on the recording medium such that the object information, the image information, the sound signal, and the time point information are associated with each other, the time point information indicating a time point at which the object information was acquired, a time point at which the image information was acquired, and a time point at which the sound signal was acquired,
the reading unit reads the sound signal from the recording medium and reads the object information and the image information that are associated with the time point information corresponding to the event occurrence time point of the selected event from the recording medium,
the display unit displays the sound signal read by the reading unit in a time-series graph such that a change in the sound signal over time can be visually recognized,
the display unit displays the object information and the image information read by the reading unit such that the object information and the image information are associated with the time-series graph, and
the display unit displays a position on the time-series graph at a time point corresponding to the event occurrence time point of the selected event.

9. The information recording system according to claim 8,
wherein, when an event position has been specified in the sound signal displayed by the display unit, the instruction reception unit receives the event selection instruction and the event position is a position corresponding to the event occurrence time point of the selected event, and
after the event selection instruction is received by the instruction reception unit, the display unit displays the object information and the image information read by the reading unit such that the object information and the image information are associated with the time-series graph.

10. The information recording system according to claim 1, wherein, when a state of the object indicated by the object information is a state predefined as an event detection condition, the event detection unit detects the event.

11. The information recording system according to claim 1,
wherein the image acquisition unit acquires the image information including an image of surroundings of the object, and
the event detection unit detects the event when a state of the surroundings of the object indicated by the image information is a state predefined as an event detection condition.

12. The information recording system according to claim 1, further comprising a sound acquisition unit configured to acquire sound information based on a sound uttered by an observer who observes the object, the sound information being a time-series sound signal,
wherein, when amplitude or power of the sound signal exceeds a threshold value predefined as an event detection condition, the event detection unit detects the event.

13. The information recording system according to claim 1, further comprising a sound acquisition unit configured to acquire sound information based on a sound uttered by an observer who observes the object,
wherein, when a sound indicated by the sound information is the same as a sound of a keyword predefined as an event detection condition, the event detection unit detects the event.

14. The information recording system according to claim 1, further comprising:
a sound acquisition unit configured to acquire sound information based on a sound uttered by an observer who observes the object; and
a sound processing unit configured to convert the sound information acquired by the sound acquisition unit into text information,
wherein, when a keyword indicated by the text information is the same as a keyword predetermined as an event detection condition, the event detection unit detects the event.

15. An information recording device comprising:
an input unit to which object information acquired by an object information acquisition unit and image information indicating a situation in which the object information was acquired by the object information acquisition unit are input, the object information being information about an object;
a recording unit configured to record the object information, the image information, and time point information on a recording medium such that the object information, the image information, and the time point information are associated with each other, the time point information indicating a time point at which the object information was acquired and a time point at which the image information was acquired;
an event detection unit configured to detect an event on the basis of at least one piece of the object information and the image information recorded on the recording medium, the event being a state in which the at least one piece of the object information and the image information recorded on the recording medium satisfies a predetermined condition, and
a reading unit configured to read the object information and the image information that are associated with the time point information corresponding to an event occurrence time point that is a time point at which the event occurred from the recording medium.

16. An information recording method comprising:
an object information acquisition step in which an object information acquisition unit acquires object information about an object;
an image acquisition step in which an image acquisition unit acquires image information indicating a situation in which the object information was acquired by the object information acquisition unit;
a recording step in which a recording unit records the object information, the image information, and time point information on a recording medium such that the object information, the image information, and the time point information are associated with each other, the time point information indicating a time point at which the object information was acquired and a time point at which the image information was acquired;
an event detection step in which an event detection unit detects an event on the basis of at least one piece of the object information and the image information, the event being a state in which the at least one piece of the object information and the image information recorded on the recording medium satisfies a predetermined condition;
a reading step in which a reading unit reads the object information and the image information that are associated with the time point information corresponding to an event occurrence time point that is a time point at which the event occurred from the recording medium; and
a display step in which a display unit displays the object information and the image information read by the reading unit such that the object information and the image information are associated with each other.
